(19) United States
(12) Patent Application Publication
(10) Pub. No.: US 2023/0347514 A1
(43) Pub. Date: Nov. 2, 2023

(54) ROBOT CONTROLLING METHOD, ROBOT AND STORAGE MEDIUM

(71) Applicant: Shenzhen Pengxing Intelligent Research Co., Ltd., Shenzhen (CN)

(72) Inventors: ZHI-GUANG XIAO, Shenzhen (CN); DA-KE ZHENG, Shenzhen (CN); SHENG-JUN CHEN, Shenzhen (CN)

(73) Assignee: Shenzhen Pengxing Intelligent Research Co., Ltd., Shenzhen (CN)

(21) Appl. No.: 18/141,227

(22) Filed: Apr. 28, 2023

(30) Foreign Application Priority Data
Apr. 28, 2022 (CN) 202210455122.4

(51) Int. Cl. B25J 9/16; B25J 13/08; B62D 57/032

(52) U.S. Cl. CPC B25J 9/1664; B25J 13/089; B62D 57/032

(57) ABSTRACT

A robot controlling method applied to a robot is provided. In the method, the robot obtains a target position and a current position of a robot, obtains a target floor of a target building according to the target position, obtains an initial floor of the target building according to the current position of the robot, generates an indoor expected passable map according to the target floor and the initial floor, generates an indoor planned path according to the indoor expected passable map, the current position, and the target position, and controls the robot to move according to the indoor planned path. The method can help the robot performing tasks in a multi-floor building.

### FIELD

The present disclosure relates to a robot technology, in particular to a robot controlling method, a robot, and a storage medium.

### BACKGROUND

Indoor is an important working place for robot, and existing buildings are usually multi-floor structures. If the robot works in a multi-floor indoor environment, the robot needs to be able to plan a route in the multi-floor building. However, the robot lacks the ability to plan paths in the multi-floor buildings, so it is difficult to work in the multi-floor buildings.

### BRIEF DESCRIPTION OF THE DRAWINGS

FIG. 1 is a block diagram of modules of a robot provided by an embodiment of the present disclosure.

FIG. 2 is a schematic structural diagram of a robot provided by an embodiment of the present disclosure.

FIG. 3A is a flowchart of a robot controlling method provided by an embodiment of the present disclosure.

FIG. 3B is a block diagram of modules of a robot controlling device provided by an embodiment of the present disclosure.

FIG. 4A is a flowchart of a robot controlling method provided by an embodiment of the present disclosure.

FIG. 4B is another block diagram of modules of a robot controlling device provided by an embodiment of the present disclosure.

FIG. 5 is another schematic flowchart of a robot controlling method provided by an embodiment of the present disclosure.

FIG. 6A is a block diagram of an adjacent-floor module of a robot provided by an embodiment of the present disclosure.

FIG. 6B is another block diagram of an adjacent-floor module of a robot provided by an embodiment of the present disclosure.

FIG. 7 is another schematic flowchart of a robot controlling method provided by an embodiment of the present disclosure.

FIG. 8A is a block diagram of a multi-floor module of a robot provided by an embodiment of the present disclosure.

FIG. 8B is another block diagram of the multi-floor module of the robot according to the embodiment of the present disclosure.

FIG. 9A is another schematic flowchart of a robot controlling method provided by an embodiment of the present disclosure.

FIG. 9B is another block diagram of a robot controlling device provided by an embodiment of the present disclosure.

FIG. 9C is another block diagram of a robot controlling device provided by an embodiment of the present disclosure.

FIG. 10A is another schematic flowchart of a robot controlling method provided by an embodiment of the present disclosure.

FIG. 10B is another block diagram of a robot controlling device provided by an embodiment of the present disclosure.

FIG. 10C is another block diagram of a robot controlling device provided by an embodiment of the present disclosure.

FIG. 11A is another schematic flowchart of a robot controlling method provided by an embodiment of the present disclosure.

FIG. 11B is another block diagram of a robot controlling device provided by an embodiment of the present disclosure.

FIG. 11C is another block diagram of a robot controlling device provided by an embodiment of the present disclosure.

FIG. 12 is another schematic flowchart of a robot controlling method provided by an embodiment of the present disclosure.

FIG. 13A is a top view of path planned by the robot provided by an embodiment of the present disclosure.

FIG. 13B is a side view of path planned by the robot provided by an embodiment of the present disclosure.

FIG. 14A is a schematic diagram of an application environment of the robot controlling method between a robot and a computer-readable storage medium provided by an embodiment of the present disclosure.

FIG. 14B is another schematic diagram of an application environment of the robot controlling method between a robot and a computer-readable storage medium provided by an embodiment of the present disclosure.

FIG. 15 is a schematic structural view of an interior of a target building provided by an embodiment of the present disclosure.

### DETAILED DESCRIPTION

To more clearly understand the present disclosure, some definitions of selected terms employed in the embodiment are given. The definitions include various examples and/or forms of components that fall within the scope of a term and that may be used for implementation. The examples are not intended to be limiting. Furthermore, the components discussed herein, may be combined, omitted, or organized with other components or into different architectures.

It should be noted that, in this disclosure, “at least one” refers to one or more, and “a plurality of” refers to two or more than two. “And/or” refers to an association relationship between associated objects, representing that three relationships may exist. For example, A and/or B may include a case where A exists separately, A and B exist simultaneously, and B exists separately. Wherein A and B may be singular or plural. The terms “first”, “second”, “third”, “fourth”, etc. in the description and claims and drawings of the disclosure are used for distinguishing similar objects, rather than for describing a specific sequence or order.

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

FIG. 1 is a schematic diagram of a multi-legged robot 100 provided by an embodiment of the present disclosure. In at least one embodiment, the multi-legged robot 100 includes a mechanical device 101, a communication device 102, at least one sensor 103, an interface device 104, a storage device 105, a processor 110, and a power supply 111. The various components of the multi-legged robot 100 may be connected in any manner, including by wired or wireless connections and the like. Those skilled in the art can understand the specific structure of the multi-legged robot 100 shown in FIG. Components are not essential components of the multi-legged robot 100 and can be omitted or combined according to needs without changing the essence of the application.

The following is a specific introduction to the various components of the multi-legged robot 100, as shown in FIG. 1.

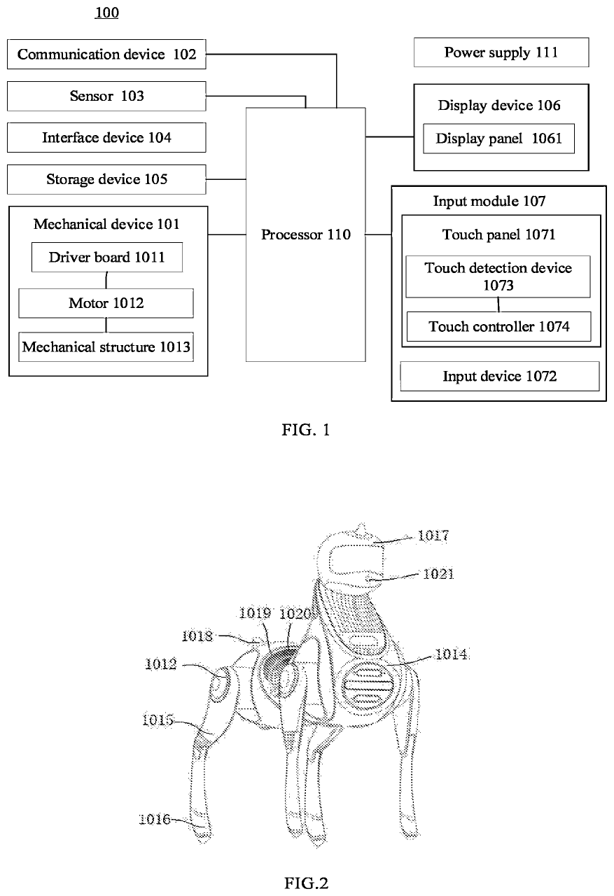

The mechanical device 101 is part of the hardware of the multi-legged robot 100. As shown in FIG. 1, the mechanical device 101 may include a driver board 1011, a motor 1012, and a mechanical structure 1013, as shown in FIG. 2. The mechanical structure 1013 may include a body 1014, an extendable leg 1015, and at least one foot 1016. In other embodiments, the mechanical structure 1013 may also include an extendable robotic arm (not shown), a rotatable head structure 1017, a wagable tail structure 1018, a load structure 1019, a saddle structure 1020, a camera device 1021, and so on. It should be noted that each component of the mechanical device 101 can be one or more and can be set according to specific conditions. For example, the mechanical device 101 may include four legs 1015, and each leg 1015 can be equipped with three motors 1012. Then, the mechanical device 101 may include twelve motors 1012.

The communication device 102 may receive and send signals and may also communicate with the network and other devices. For example, after the communication device 102 receives command sent by a remote controller or other multi-legged robot 100 to move in a predetermined direction at a predetermined speed according to a predetermined gait, the communication device 102 transmits the command to the processor 110. The communication device 102 includes, for example, a Wi-Fi device, a 4G device, a 5G device, a Bluetooth, an infrared device, and the like.

The at least one sensor 103 acquires information of a surrounding environment of the multi-legged robot 100 and monitors parameters of the components of the multi-legged robot 100 and sends the information and the parameters to the processor 110. The at least one sensor 103 for acquiring surrounding environment information includes a laser radar (for long-range object detection, distance determination and/or speed value determination), a millimeter-wave radar (for short-range object detection, distance determination and/or or speed value), a camera, an infrared camera, a Global Navigation Satellite System (Global Navigation Satellite System, GNSS), etc. The at least one sensor 103 for monitoring parameters of the components of the multi-legged robot 100 includes an inertial measurement module (Inertial Measurement Module, IMU) (for measuring the value of velocity value, acceleration value and angular velocity value), a plantar sensor (for monitoring a position of a plantar force point, a foot posture, a ground contact force size and direction), a temperature sensor (used to detect component temperature). As for other sensors such as load sensors, touch sensors, motor angle sensors, and torque sensors that can be configured on the multi-legged robot 100 will not be introduced here.

The interface device 104 receives information (e.g., data information, power, etc.) from an external device and sends the received information to one or more components of the multi-legged robot 100. The interface device 104 may include a power port, a data port such as a USB port, a memory card port, a port for connecting a device with an identification device, an audio input/output (I/O) port, a video I/O port, and the like.

The storage device 105 stores software programs and various data. The storage device 105 can mainly include a program storage state and a data storage state. The program storage state can store operating system programs, motion control programs, application programs (such as text editors), etc. The data storage state can store data generated by the multi-legged robot 100 when the multi-legged robot 100 is working (such as various sensing data acquired by the at least one sensor 103, log file data) and the like. In addition, the storage device 105 may include a high-speed random-access memory, and may also include a non-volatile memory, such as a magnetic disk memory, a flash memory, or other volatile solid-state memory.

The display device 106 displays information input by a user or information provided to the user. The display device 106 may include a display panel 1061, and the display panel 1061 may include a liquid crystal display (Liquid Crystal Display, LCD), an organic light-emitting diode (Organic Light-Emitting Diode, OLED), or the like.

The input module 107 can receive numeric or character information. Specifically, the input module 107 may include a touch panel 1071 and other input devices 1072. The touch panel 1071, also referred to as a touch screen, can collect touch operations (for example, operations input on the touch panel 1071 or near the touch panel 1071 by palms or fingers of the user, or accessories). The touch panel 1071 may include two parts, a touch detection device 1073 and a touch controller 1074. The touch detection device 1073 detects the user's touch orientation, detects the signal generated by the touch operation, and transmits the signal to the touch controller 1074. The touch controller 1074 receives the touch information from the touch detection device 1073, and converts the touch information into point coordinates, and sends the point coordinates to the processor 110. The touch processor 110 receives and executes commands sent by the processor 110. In addition to the touch panel 1071, the input module 107 may also include other input devices 1072. Specifically, other input devices 1072 may include, but are not limited to, one or more of remote controller handles, etc., which are not specifically limited here.

Further, the touch panel 1071 includes a display panel 1061, and when the touch panel 1071 detects a touch operation on or near the touch panel 1071. The touch panel 1071 transmits the signal generated by the touch operation to the processor 110 to determine a type of the touch operation, and then the processor 110 control the display panel 1061 to provide a corresponding visual output according to the determined type of the touch operation. In FIG. 1, the touch panel 1071 and the display panel 1061 are used as two independent components to realize the input and output functions respectively, in some embodiments, the touch panel 1071 and the display panel 1061 can be integrated to realize the input and output functions are not limited here.

The processor 110 is a control center of the multi-legged robot 100. The processor 110 uses various interfaces and lines to connect the various parts of the multi-legged robot 100 and controls the multi-legged robot 100 by running or executing the software program stored in the storage device 105, and by calling the data stored in the storage device 105.

The power supply 111 supplies power to various components of the multi-legged robot 100. The power supply 111 may include a battery and a power control board. The power control board is used to control functions such as battery charging, discharging, and power consumption management. In the embodiment shown in FIG. 1, the power supply 111 is electrically connected to the processor 110. In other embodiments, the power supply 111 can also be electrically connected to the at least one 103 (such as a camera, radar, speaker, etc.) and the motor 1012. It should be noted that each component may be connected to different power supply 111 or powered by the same power supply 111.

According to the above embodiments, specifically, in some embodiments, a terminal device is communicated with the multi-legged robot 100. The terminal device sends instructions to the multi-legged robot 100, and the multi-legged robot 100 receives the instructions from the communication device 102 and transmits them to the processor 110. The processor 110 obtains a target speed according to the instructions. The terminal device includes, but is not limited to, mobile phones, tablet computers, servers, personal computers, wearable smart devices, and other electrical equipment with image capture functions.

The instructions are set by preset conditions. In one embodiment, the multi-legged robot 100 includes at least one sensor 103, and at least one sensor 103 generates instructions according to the current environment in which the multi-legged robot 100 is located. The processor 110 determines whether the current speed of the multi-legged robot 100 satisfies a corresponding preset condition according to the instructions. In response to the fact that the current speed satisfies the corresponding preset condition, the processor 110 controls the multi-legged robot 100 to move according to the current speed and a current gait. In response to the fact that the current speed does not satisfy the corresponding preset condition, the processor 110 determines the target speed and the corresponding target gait according to the corresponding preset conditions and controls the multi-legged robot 100 to move according to the target speed and the corresponding target gait. The at least one sensor 103 includes temperature sensors, air pressure sensors, visual sensors, and sound sensors. The instruction includes temperature information, air pressure information, image information, and sound information. A communication mode between the at least one sensor 103 and the processor 110 may be wired communication or wireless communication. Ways of wireless communication include, but are not limited to, wireless networks, mobile communication networks (3G, 4G, 5G, etc.), Bluetooth, and infrared.

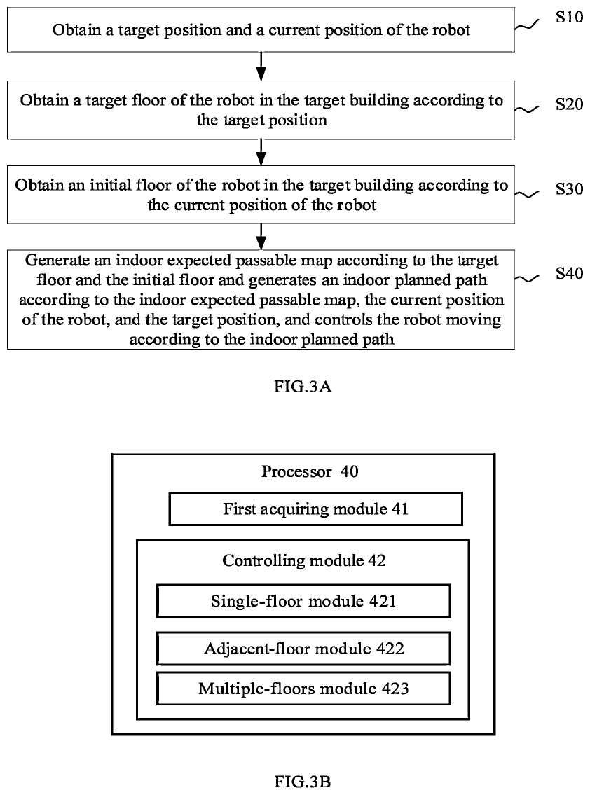

FIG. 3A is a flowchart of a robot control method provided by an embodiment of the present disclosure. The robot control method can be performed by using a robot 100 (for example, the multi-legged robot 100 of FIG. 2). According to different requirements, an order of each block in the flowchart can be adjusted according to actual detection requirements, and some blocks can be omitted. In at least one embodiment, the robot controlling method can include the following blocks.

In block S10, the robot 100 processor 110 obtains a target position and a current position of the robot 100.

In block S20, the robot 100 processor 110 obtains a target floor of the robot 100 in the target building according to the target position.

In block S30, the robot 100 processor 110 obtains an initial floor of the robot 100 in the target building according to the current position of the robot 100.

In block S40, the robot 100 processor 110 generates an indoor expected passable map according to the target floor and the initial floor and generates an indoor planned path according to the indoor expected passable map, the current position of the robot 100, and the target position, and controls the robot 100 to move according to the indoor planned path.

Please refer to FIG. 3B, the processor 40 of the robot 100 according to the embodiment of the present disclosure includes a first acquiring module 41 and a controlling module 42. The robot controlling method provided by the present disclosure can be implemented by the processor 40 of the robot 100. Blocks S10-S30 can be implemented by the first acquiring module 41, and the Block S40 can be implemented by the controlling module 42.

The first acquiring module 41 is used to obtain the target position and the current position of the robot 100 and obtain the target floor of the robot 100 in the target building according to the target position and obtain the initial floor of the robot 100 in the target building according to the current position of the robot 100.

The controlling module 42 is used to acquire an indoor expected passable map according to the target floor and the initial floor of the robot 100 in the target building, and acquire an indoor planned path according to the indoor expected passable map, the current position, and the target position of the robot 100, and control the robot 100 to move according to the indoor planned path.

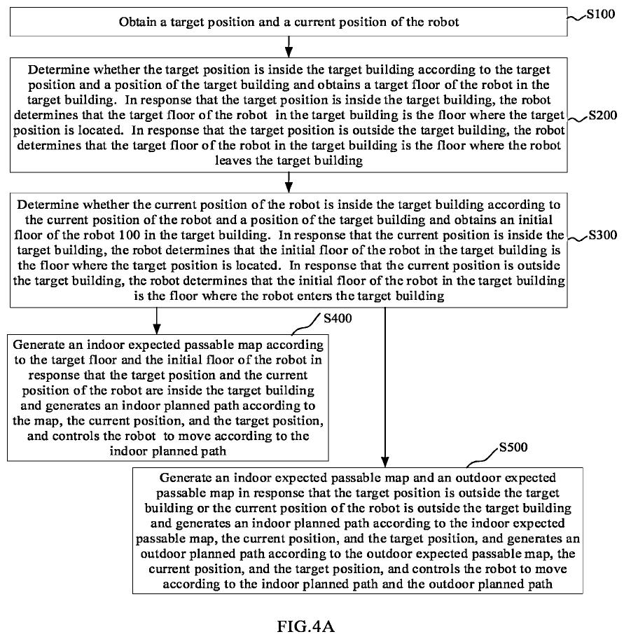

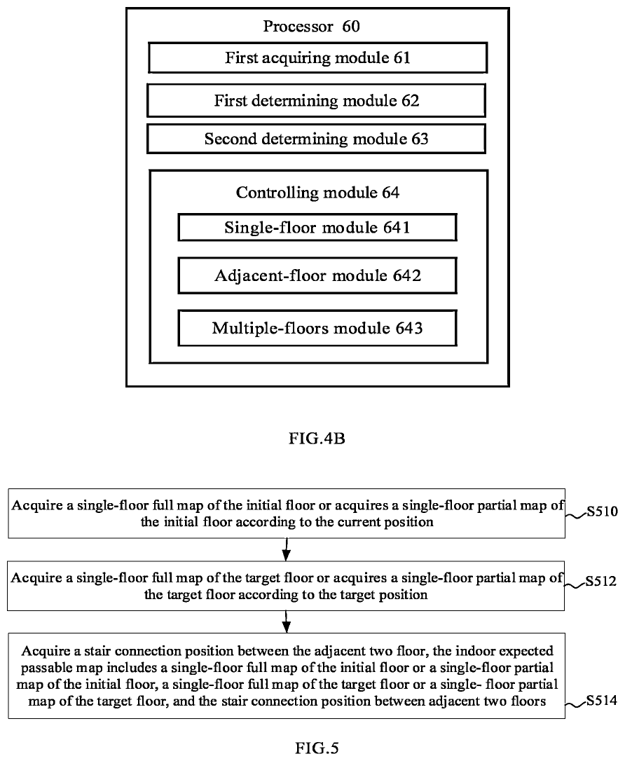

Referring to FIG. 4A, in some embodiments, the robot 100 can work inside and outside buildings, and the robot controlling method in this embodiment includes:

In block S100, the robot 100 obtains a target position and a current position of the robot 100.

In block S200, the robot 100 determines whether the target position is inside the target building according to the target position and a position of the target building and obtains a target floor of the robot 100 in the target building. In response that the target position is inside the target building, the robot 100 determines that the target floor of the robot 100 in the target building is the floor where the target position is located. In response that the target position is outside the target building, the robot 100 determines that the target floor of the robot in the target building is the floor where the robot 100 leaves the target building.

In block S300, the robot 100 determines whether the current position of the robot 100 is inside the target building according to the current position of the robot 100 and a position of the target building and obtains an initial floor of the robot 100 in the target building. In response that the current position is inside the target building, the robot 100 determines that the initial floor of the robot 100 in the target building is the floor where the target position is located. In response that the current position is outside the target building, the robot 100 determines that the initial floor of the robot in the target building is the floor where the robot enters the target building.

In block S400, the robot 100 generates an indoor expected passable map according to the target floor and the initial floor of the robot in response that the target position and the current position of the robot are inside the target building and generates an indoor planned path according to the map, the current position, and the target position, and controls the robot 100 to move according to the indoor planned path.

In block S500, the robot 100 generates an indoor expected passable map and an outdoor expected passable map in response that the target position is outside the target building or the current position of the robot is outside the target building and generates an indoor planned path according to the indoor expected passable map, the current position, and the target position, and generates an outdoor planned path according to the outdoor expected passable map, the current position, and the target position, and controls the robot 100 to move according to the indoor planned path and the outdoor planned path.

Please refer to FIG. 4B, the processor 60 of the robot 100 according to the embodiment of the present disclosure includes a first acquiring module 61, a first determining module 62, a second determining module 63 and a controlling module 64. The robot controlling method provided by the present disclosure can be implemented by the processor 60 of the robot 100. Blocks S100 can be implemented by the first acquiring module 61, and the Block S200 can be implemented by the first determining module 62, and the Block S300 can be implemented by the second determining module 63, and the Block S400 and S500 can be implemented by the controlling module 64.

The first acquiring module 61 is used to acquire a target position and a current position of the robot 100.

The first determining module 62 is used to determine whether the target position is inside the target building according to the target position and a position of the target building and obtains a target floor of the robot 100 in the target building. In response that the target position is inside the target building, the first determining module 62 is used to determine that the target floor of the robot 100 in the target building is the floor where the target position is located. In response that the target position is outside the target building, the first determining module 62 is used to determine that the target floor of the robot in the target building is the floor where the robot 100 leaves the target building.

The second determining module 63 is used to determine whether the current position of the robot 100 is inside the target building according to the current position of the robot 100 and a position of the target building and obtains an initial floor of the robot 100 in the target building. In response that the current position is inside the target building, the second determining module 63 is used to determine that the initial floor of the robot 100 in the target building is the floor where the target position is located. In response that the current position is outside the target building, the second determining module 63 is used to determine that the initial floor of the robot 100 in the target building is the floor where the robot enters the target building.

The controlling module 64 is used to generate an indoor expected passable map and an outdoor expected passable map in response that the target position is outside the target building or the current position of the robot is outside the target building and generates an indoor planned path according to the indoor expected passable map, the current position, and the target position, and obtains an outdoor planned path according to the outdoor expected passable map, the current position, and the target position, and controls the robot 100 to move according to the indoor planned path and the outdoor planned path.

It should be noted that the robot 100 includes but is not limited to a humanoid robot, a robot dog, a sweeping robot, etc., and there is no limitation here.

The robot controlling method provided by the present disclosure can obtain a multi-floor passable map based on several single-floor passable maps and connection of the stairs between adjacent two floors. The robot controlling method enables the robot 100 to path planning according to the multi-floor passable map, and makes the robot 100 to perform tasks in the multi-floor building.

Specifically, there are many ways to obtain the current position of the robot 100, and examples are given below. In at least one embodiment, the first acquiring module 41 of the processor and the first acquiring module 61 of the processor 60 acquires the current position of the robot 100 through a positioning module. In at least one embodiment, the current position of the robot 100 can be set by a user. In one embodiment, the controller sets an initial pose of the robot 100, records the movement data of the robot 100, and calculates the current position of the robot 100 according to the movement data and the initial pose of the robot 100.

In at least one embodiment, the controller acquires the target position of the robot by many ways, and examples are given below. In at least one embodiment, the target position can be a relatively accurate target position. For example, the target position can be a position of some relatively fixed electrical appliances in the room, such as TV, refrigerator, washing machine, etc. The target position also can be a fixed location of the building, such as an entrance of the stairs, a door of the bedroom on the third floor, and a door of a bathroom on the first floor.

In at least one embodiment, the target position may be an area with relatively independent space, for example, an area with independent space such as bedrooms on the second floor and third floor.

In at least one embodiment, the target position may be a location deduced according to a probability. For example, in response that the controller receives a user instruction “find a mobile phone for me”, the controller of the robot can first determine the target position of the mobile phone based on past experience with a relatively high probability (for example, next to a charger in the bedroom of the third floor with the highest probability, next to the charger in the TV cabinet on the first floor with a medium probability, and the bathroom with the lowest probability).

In one embodiment, the target position is generated by the robot 100 automatically. For example, whenever a battery capacity of the robot 100 is too low, or the robot 100 automatically returns to the charging port for charging every night, and the target position is the location of the charging port.

It should be noted that the target position includes a position which is located outside the target building or a position which is located inside the target building. The target position includes a position which is located on a floor or a staircase within a floor. The current position includes a position which is located outside the target building or a position which is located inside the target building, and a position which is located on a floor or a staircase within a floor.

The expected passable map includes a passable state and an impassable state. The robot 100 can pass in the passable state and cannot pass in the impassable state. Specifically, the controller can distinguish the passable state from the impassable state by removing the impassable state in the map and mark the passable state in the map. Specifically, the controller can divide the passable state and the impassable state in the expected passable map according to a traffic capacity of the robot 100, a slope of the area, an unevenness of the area, etc., which will not be described in detail here.

It can be understood that, according to the target position and the current position of the robot 100, the acquired expected passable map includes a map required to move from the current position to the target position. The planned path is a path from the current position of the robot 100 to the target position.

In at least one embodiment, the controller uses an A* algorithm or a D* algorithm for calculating the planned path. Specifically, the A* algorithm or the D* algorithm is widely used in path planning, which belongs to the prior art, and will not be described in detail here.

It can be understood that, in the block S500, in one embodiment, the target position is outside the target building, and the current position of the robot is inside the target building. In another embodiment, the target position is inside the target building, and the current position of the robot is outside the target building. In the above two embodiments, the planned path is calculated based on the indoor expected passable map and the outdoor expected passable map. In the following embodiments, the method for obtaining the indoor expected passable map is mainly described. It can be understood that the method for obtaining the outdoor expected passable map is similar to the method for obtaining the indoor expected passable map. The difference is that the outdoor expected passable map can be understood as a map on the same floor, and generally there is no cross-floor situation.

In at least one embodiment of the present disclosure, the planned path includes one or more paths. For example, the initial floor is on the first floor and the target floor is on the second floor. The path planned by the robot 100 from the first floor to the second floor includes: a first path from the current position on the first floor to a stair connection position between the first floor and the second floor, and a second path from the stair connection position to the target position on the second floor. The path planned by the robot 100 according to a start point to an end point on each map, and in two adjacent maps, the end point of the previous map is used as the start point of the next map. For example, a first map is a map of the first floor, and the first path belongs to the first map. A second map is a map of the second floor, and the second path belongs to the second map. The stair connection position between the first floor and the second floor is on the first map and the second map. Then the path planned by the robot 100 according to the current position on the first floor, the stair connection position, and the target position on the second floor. A start point of the first path of the first map is the current position on the first floor, and an end point of the first path of the first map is the stair connection position. A start point of the second path of the second map is the stair connection position, and an end point of the second path of the second map is the target position on the second floor.

In some embodiments, in response that the target floor and the initial floor of the robot 100 in the target building are the same floor of the target building, the controller acquires an indoor expected passable map of the block S40, or the block S400 and block S500 includes: acquiring a single-floor full map of an initial floor or acquiring a single-floor partial map of the initial floor based on the current position and the target position.

The indoor expected passable map includes a single-floor full map of the initial floor or a single-floor partial map of the initial floor.

In this way, is response that the target floor and the initial floor of the robot 100 in the target building are the same floor of the target building, an indoor expected passable map can be obtained to facilitate subsequent path planning.

In some embodiments, please refer to FIG. 3B and FIG. 4B, the controller 42 includes a single-floor module 421, the block S40 can be implemented by the single-floor module 421, the controller 64 includes a single-floor module 641, and blocks S400 and S500 can be implemented by the single-floor module 621. In response that the target floor and the initial floor of the robot 100 in the target building are the same floor of the target building, the single-floor module 421 and the single-floor module 641 are used to acquires the single-floor full map or a single-floor partial map of the initial floor is according to the current position and the target position. And the indoor expected passable map includes the single-floor full map of the initial floor or the single-floor partial map of the initial floor.

Specifically, in one embodiment, the single-floor full map may be a single-floor full passable map obtained after performing a passable judgment according to the single-floor full elevation map. The single-floor partial map can be a single-floor partial passable map obtained after performing the passable judgment according to the single-floor partial elevation map.

The target floor and the initial floor of the robot 100 in the target building are the same floor of the target building, which may be understood as the target floor and the initial floor are in the same floor of the indoor expected passable map. For example, if there is a gentle slope with a height of 1 m in the target building, the initial floor is on an uphill of the gentle slope, and the target floor is on a downhill of the gentle slope. In the case where the uphill and downhill of the gentle slope are set as one floor in the indoor expected passable map, the target floor and the initial floor are the same floor of the target building. When the uphill and downhill of the gentle slope are set as two floors in the indoor expected passable map, the target floor and the initial floor are not on the same floor of the target building.

In one embodiment, in response that the target position or the current position of the robot 100 is not on the stairs, then the controller obtains the single-floor expected passable map of the robot 100 in the target building. In response that both the target position and the current position of the robot 100 are on the stairs, then the controller obtains the single-floor expected passable map of the robot 100 or obtains a passable map of the stair position area on the target floor in the target building.

In one embodiment, the controller determines whether the target floor and the initial floor are the same floor of the target building according to an elevation map of the same floor.

In some embodiments, please refer to FIG. 5, in response that the target floor and the initial floor of the robot 100 in the target building are adjacent two floors of the target building, the controller obtains the indoor expected passable map in block S40 or blocks S400 and S500 includes:

Block S510, the robot 100 acquires a single-floor full map of the initial floor or acquires a single-floor partial map of the initial floor according to the current position.

Block S512, the robot 100 acquires a single-floor full map of the target floor or acquires a single-floor partial map of the target floor according to the target position.

Block S514, the robot 100 acquires a stair connection position between the adjacent two floors.

The indoor expected passable map includes a single-floor full map of the initial floor or a single-floor partial map of the initial floor, a single-floor full map of the target floor or a single-floor partial map of the target floor, and the stair connection position between adjacent two floors.

In one embodiment, in response that the robot goes from a sofa on the first floor of the initial floor to the stairs on the second floor of the target floor, the controller of the robot can obtain a single-floor full map of the first floor or obtain a single-floor partial map of the first floor based on the current position. For example, the controller obtains the partial map within a range from the sofa to the stairs, the single-floor full map of the second floor or the single-floor partial map of the second floor according to the target position. When the controller determines the passable state, the stair connection position between the two floors is determined as an impassable state. The controller further obtains the position of the stair connection position between the first and the second floors. Compared with obtaining a single-floor full map, the controller obtains a single-floor partial map can improve a calculation speed for determining the passable state.

In in response that the target floor and the initial floor of the robot 100 in the target building are adjacent two floors of the target building, an indoor expected passable map can be obtained to facilitate subsequent path planning.

Specifically, in one embodiment, the single-floor full map may be a single-floor full passable map obtained after the controller making a passable judgment based on the single-floor full elevation map. The single-floor partial map may be a single-floor partial passable map obtained after the controller making a passable judgment based on the single-floor partial elevation map. In order to save the calculation speed of the passable state, when the robot does not need to pass through most areas of the floor, the controller can obtain the single-floor partial map of the initial floor according to the current position or obtain the single-floor partial map of the target floor according to the target location.

Each single-floor map has a boundary, and part of the boundaries between the single-floor maps are connected, such as areas with stairs, gentle slopes, etc., and the boundaries in each single-floor map are usually determined as impassable states when the controller determines whether the boundaries are passable states. Therefore, when the controller determines whether a single-floor map is a passable state, the boundaries of the single-floor map are usually determined as impassable states, and the stair connection position between adjacent two floors is impassable state.

If the target floor and the initial floor of the robot 100 in the target building are adjacent two floors of the target building, the indoor planned path is obtained in block S40 or blocks S400 and S500, and the robot 100 obtains the indoor planned path includes:

Situation one: in response that the stair connection positions between adjacent two floors are all in impassable state, and the controller does not receive any path operation instructions, the controller changes at least one of the stair connection positions between adjacent two floors to a passable state, and plans the indoor planned path according to a preset strategy.

The path operation instruction is an instruction that the path be planned without going through a stair connection position between adjacent two floors, or an instruction that the path be planned needs to go through the stair connection position between adjacent two floors. In one embodiment, before the robot performs path planning, there are four stair connection positions 1-4 between the initial floor (1st floor) and the target floor (2nd floor), when the controller determines whether the single-floor map includes a passable state, the controller determines that the four stair connection positions 1-4 are in impassable state. In response that no path operation instruction is received, the controller changes at least one of the four stair connection positions 1-4 as passable state and plans the path according to the preset strategy.

Situation two: in response that all the stair connection positions between the adjacent two floors are in impassable state, and the controller receives no path operation instructions, the controller assumes that all the stair connection positions are in passable state, and plans the indoor planned path according to the preset strategy, and changes the stair connection positions between the adjacent two floors on the planned path to passable state.

In one embodiment, in response that the four stair connection positions 1-4 between the initial floor (1st floor) and the target floor (2nd floor) are in impassable state, and the controller receives no path operation instructions, the controller assumes that the stair connection positions 1-4 are in passable state, and plans the path according to the preset strategy. In response that the stair connection position 1 on the 1st floor and 2nd floor is on the path, the controller changes the stair connection position 1 to the passable state.

Situation three: in response that the controller receives a path operation instruction, and the path operation instruction includes an instruction that the path does not pass through a preset stair connection position between the adjacent two floors. In response that the preset stair connection position is in passable state, the controller changes the preset stair connection position as impassable state. In response that the preset stair connection position is in impassable state, the controller remains the preset stair connection position as impassable state and plans the indoor planned path according to the preset strategy.

In one embodiment, in response that the controller receives the path operation instruction including “do not pass through the stair connection position 2 between the initial floor (1st floor) and the target floor (2nd floor)”, and the way to send the path operation instruction to the controller is not restricted. For example, the controller sets the stair connection position 2 as a virtual obstacle by a human-computer interface, in response that the stair connection position 2 is currently passable state, the controller changes the stair connection position 2 as impassable state. In response that the stair connection position 2 is currently in impassable state, the controller remains the stair connection position 2 as the impassable state. Then, in response that the other stair connection positions, such as the stair connection positions 3 and 4, are in passable state. The controller plans the path according to the stair connection positions 3 and 4 and the preset strategy. In in response that the other stair connection positions, such as the stair connection positions 1, 3 and 4, are in impassable state. The controller assumes that the stair connection positions 1, 3 and 4 are in passable state, and plans the path according to the preset strategy. For example, in response that the path needs to go through the stair connection position 1, the controller changes the stair connection positions 1 to the passable state.

Situation four: in response that the controller receives the path operation instruction which includes an instruction that the planned path needs to pass through the preset stair connection position between the adjacent two floors. In response that the preset stair connection position is in impassable state, the controller assumes that the preset stair connection position is in passable state and change the connection positions of other passable stairs to impassable stairs, and plans the path according to the preset strategy, and then changes the preset stair connection position between the adjacent two floors on the planned path to a passable state. In response that the stair connection position is in passable state, the controller changes the connection position of other passable stairs to the impassable stairs and plans the path according to the preset strategy.

In one embodiment, in response that the controller receives a path operation instruction including “go through the stair connection position 2 between the initial floor (1st floor) and the target floor (2nd floor)”, and the way to send the path operation instruction to the controller is not restricted. For example, the controller receives an instruction in response that a user ticks the stair connection position 2 by a human-computer interface. In response that the stair connection position 2 is currently in impassable state, the controller assumes that the stair connection position 2 is in passable state, and change the connection positions 1, 3 and 4 of other passable stairs to impassable stairs, and plan the path according to the preset strategy after changing the impassable stair connection position 2 to a passable stair. In response that the stair connection position 2 is in passable state, the controller changes the stair connection positions 1, 3 and 4 of other passable stairs to impassable stairs, and plan the path according to the preset strategy.

Situation five: in response that the controller receives the path operation instruction, which comprises an instruction that does not pass through the preset stair connection position between the adjacent two floors; when planning the path, consider the preset stair connection position as an impassable position and planning the path according to the preset strategy.

In one embodiment, in response that the controller receives the path operation instruction including “do not pass through the stair connection position 2 between the initial floor (1st floor) and the target floor (2nd floor)”, the controller assumes the stair connection position 2 as an impassable state when performing path planning, and the controller does not need to change the stair connection position 2 to passable state, and plans the path according to the preset strategy.

Situation six: in response that the controller receives the path operation instruction which includes an instruction that needs to pass through a preset stair connection position between the adjacent two floors. The controller sets the preset stair connection position as an intermediate destination position when planning the path and plans the path according to the preset strategy.

In one embodiment, in response that the controller receives the path operation instruction including “passing through the stair connection position 2 between the initial floor (1st floor) and the target floor (2nd floor)”, the controller sets the stair connection position 2 as the intermediate target position when planning the path, without changing the stair connection position 2 to passable state or impassable state, and plans the path from the current position to of the robot to the stair connection position 2.

Situations three to six, the controller receives the path operation instruction by a user, so that during the robot working, the robot can re-plan a new path if the user adjusts the path halfway.

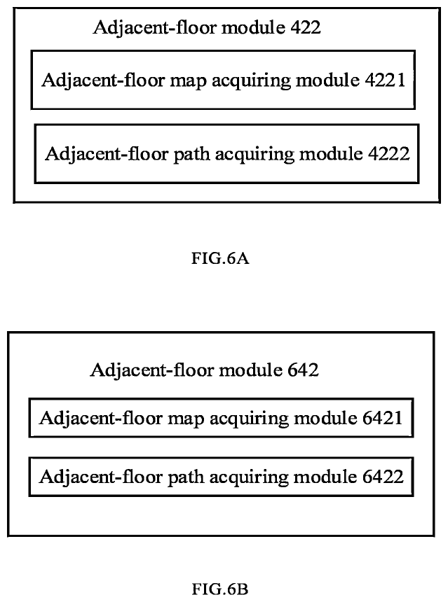

In some embodiments, referring to FIG. 3B, FIG. 4B, FIG. 6A and FIG. 6B, the controller 42 comprises an adjacent-floor module 422, the controller 64 includes an adjacent-floor module 642, the adjacent-floor module 422 includes an adjacent-floor map acquiring module 4221 and an adjacent-floor path acquiring module 422, the adjacent-floor module 642 includes an adjacent-floor map acquiring module 6421 and an adjacent-floor path acquiring module 6422. Block S40 or blocks S400 and S500 to obtain an indoor expected passable map are implemented by an adjacent-floor map acquiring module 4221 or an adjacent-floor map acquiring module 6421. Block S40 or blocks S400 and S500 to obtain an indoor planned path are obtained by an adjacent-floor path acquiring module 4222 or an adjacent-floor path acquiring module 6422.

After the user sends the path operation instruction to the robot, the robot obtains several target positions according to the path operation instruction, and the controller plans the path in accordance with an order of the several target positions sent by the user. When the robot moves to a first target position, the first target position is used as the current position, and the next target position is updated to a new target position, until the last target location is used as the target position.

Specifically, after the user sends an instruction to the robot that “go to the kitchen on the 1st floor to get an apple, and then take the mobile phone in a bedroom on the 2nd floor”, the robot first takes the kitchen on the 1st floor as the target location, and plans the indoor planned path based on the current position and the kitchen on the 1st floor, and when the robot reaches the kitchen on the 1st floor, then takes the kitchen on the 1st floor as the current position, and plans the path base on taking the bedroom on the 2nd floor as the new target location.

In one embodiment, the human-computer interaction interface includes a multi-floor map and an obstacle module (e.g., black squares, forks, etc.) and a path planned by the robot. The multi-floor map of the human-computer interface is different from the full map or partial map obtained by the robot for path planning.

In one embodiment, the human-computer interaction interface displays the full path planned by the robot on the multi-floor map. When the planned full path includes multiple segments, each segment of the path is displayed in a different way. For example, when the current floor of the robot is the 1st floor and the target floor is the 2nd floor, the controller sets the stair connection position between the 1st floor and the 2nd floor as a node of the planned full path. The planned full path includes two segments, one segment is a 1st floor path and the other segment is a 2nd floor path. The human-computer interaction interface displays the two segments in different colors so that the user knows the stair connection position of the two segments, and then sets virtual obstacles at the stair connection position as needed.

In one embodiment, when the user selects a path or a preset floor of a path need to be planned, the human-computer interaction interface displays a current selected path or a current floor map of the preset floor, the current floor map includes multiple independent spaces (such as a room, bathroom, etc.) and corresponding entrances and stairs. The user uses the obstacle module to select the location where a virtual obstacle needs to be added on the current floor map according to the demand, and the robot determines that the location is impassable according to the virtual obstacle, so as to replan the path or stop running.

For example, when the user knows that there is someone resting in the bedroom on the 1st floor, and the user will select the 1st floor map, drag or select a virtual obstacle module on the position of the bedroom door of the 1st floor of the 1st floor map through the human-computer interaction interface, or the user directly sets a fork label on the entire bedroom area of the 1st floor map. After the robot learns a position of the virtual obstacle, the robot sets the position of the bedroom door on the 1st floor to impassable state and updates the path. In one embodiment, the robot sets the bedroom area as an impassable state after the robot learns the position of the virtual obstacle. For another example, the controller usually obtains a shortest path by the path planning algorithm and displays the shortest path on the floor map of the human-computer interaction interface, when the user knows that the shortest path is currently impassable. For example, when the user knows the shortest path will pass through the first stair connection position on the 2nd floor, and the first stair connection position was occupied by goods, then the user sets a fork label at the first stair connection position on the 2nd floor and sets the obstacle module on the shortest path in advance. Then the robot replans the path.

In one embodiment, the human-computer interaction interface displays the path planned by the robot and displays a first path executed by the robot or a second path will be executed by the robot in different ways. For example, the human-computer interaction interface displays the first path and the second path in different lines or colors. The human-computer interaction interface displays the first path as a solid line, and the second path as a dotted line, so that the user can know a progress of the robot moved and determine a setting time of the virtual obstacle.

In response that there are stairs between the adjacent two floors, the controller sets the stair connection position as passable state, then the robot 100 can change position between the adjacent two floors through the stair connection position. That is, the controller sets the stair connection position as passable state according to the stair connection position on each single-floor map of the adjacent two floors.

The stair connection position includes location coordinates of a stair area. For convenience, the stair connection position can be anywhere on the stair area. The controller obtains the stair connection position according to data from any position on the stair area. In one embodiment, the stair connection position may be a central position of the stair connection. In this way, the controller sets the coordinates of the central position of the stair connection as the stair connection position and sets the central position of the stair connection as a center of a circle, and sets the circle within a preset radius as the stair area. In some embodiments, the stair connection position includes a collection of position coordinates of the stair area. In this way, the stair area can be represented in more detail.

The single-floor partial passable map can be a staircase location area passable map, according to the robot's movement from the initial position to the target position, the controller determines whether to obtain a single-floor full passable map or a single-floor partial passable map according to whether the robot goes through the staircase location area only. In response that the robot only goes through the staircase location area, the controller obtains the corresponding floor of the staircase location passable map, without obtaining a single-floor full map for the calculation of the passable state, thereby saving the calculation speed. For example, the target location of the robot 100 is on the stairs on the 2nd floor, and the current position is in the bedroom on the 1st floor, and the staircase position on the 2nd floor is immediately adjacent to the staircase position on the 1st floor, and the robot does not need to go through other areas on the 2nd floor to reach the stairs on the 2nd floor, then the controller obtains the partial passable map of the staircase location area on the 2nd floor. If the position of the stairs on the 2nd floor is not adjacent to the staircase position on the 1st floor, or if the robot needs to perform tasks in an area other than the staircase location area on the 2nd floor, that is, the robot needs to pass through an area other than the staircase location area on the 2nd floor to reach the stairs on the 2nd floor, the controller needs to obtain a single-floor full passable map on the 2nd floor.

It should be noted that the stair connection position is not the same as the physical concept of the staircase position, and the staircase connection position in the present disclosure can be both the stair connection position when the elevation map is divided on the map, and the staircase entrance position in other diagrams, without specific restrictions here. Specifically, please refer to FIG. 15, which shows a schematic diagram of the structure in the target building, and a dividing line is the line dividing the first floor and the second floor on the elevation map, and a junction of the dividing line and the staircase can be set as the stair connection position. And the position of the stairway in the edge area of other graphs also can be set as the stair connection position.

In one embodiment, the controller determines whether the target floor and the initial floor are adjacent floors of the target building according to the elevation maps of the adjacent floors.

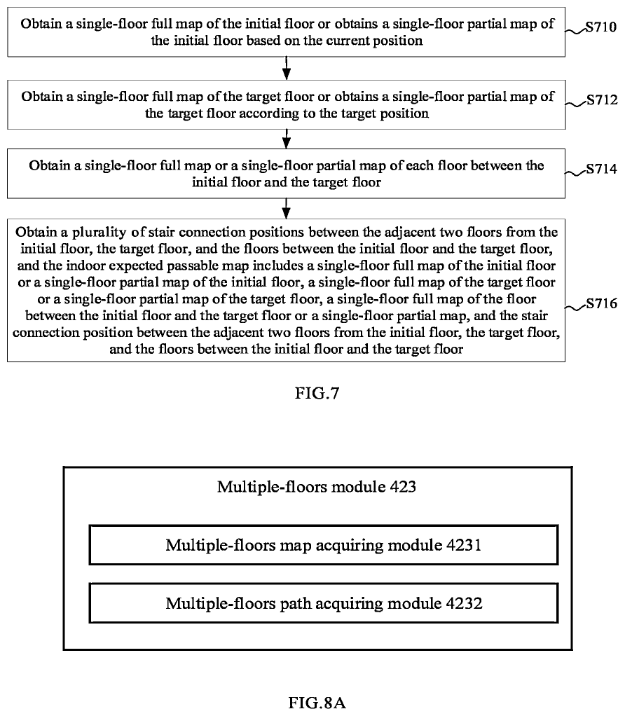

In at least one embodiment, refer to FIG. 7, the target floor and the initial floor of the robot 100 in the target building are separated by at least one floor in the target building, block S40 or blocks S400 and S500 to obtain an indoor expected passable map includes:

Block S710, the robot 100 obtains a single-floor full map of the initial floor or obtains a single-floor partial map of the initial floor based on the current position.

Block S712, the robot 100 obtains a single-floor full map of the target floor or obtains a single-floor partial map of the target floor according to the target position.

Block S714, the robot 100 obtains a single-floor full map or a single-floor partial map of each floor between the initial floor and the target floor.

Block S716, the robot 100 obtains a plurality of stair connection positions between the adjacent two floors from the initial floor, the target floor, and the floors between the initial floor and the target floor.

The controller generates the indoor expected passable map, and the indoor expected passable map includes a single-floor full map of the initial floor or a single-floor partial map of the initial floor, a single-floor full map of the target floor or a single-floor partial map of the target floor, a single-floor full map of the floor between the initial floor and the target floor or a single-floor partial map, and the stair connection position between the adjacent two floors from the initial floor, the target floor, and the floors between the initial floor and the target floor.

In one embodiment, for example, the target position of the robot 100 is in the kitchen on the 3rd floor, and the current position is in the bedroom on the 1st floor. Because the staircase position on the 2nd floor is immediately adjacent to the staircase position on the 1st floor, the robot does not need to go through other areas on the 2nd floor to reach the staircase on the 2nd floor. If the staircase position on the 2nd floor is not adjacent to the staircase position on the 1st floor or if the robot needs to perform tasks in an area other than the staircase location area on the 2nd floor. The robot needs to pass through an area other than the staircase location area on the 2nd floor to reach the stairs on the 2nd floor, and the robot needs to obtain a single-floor full passable map on the 2nd floor. The robot's ability to obtain a single-floor partial map improves the calculation speed of the passable state judgment compared to obtaining a single-floor full map.

In block S40 or blocks S400 and S500, the controller obtains the indoor planned path includes:

Situation one: in response that the stair connection positions between adjacent two floors are all in impassable state, and the controller does not receive any path operation instructions, the controller changes at least one of the stair connection positions between adjacent two floors to a passable state and plans the indoor planned path according to a preset strategy.

Situation two: in response that all the stair connection positions between the adjacent two floors are in impassable state, and the controller receives no path operation instructions, the controller assumes that all the stair connection positions are in passable state, and plans the indoor planned path according to the preset strategy, and changes the stair connection positions between the adjacent two floors of the planned path to passable state.

Situation three: in response that the controller receives a path operation instruction, and the path operation instruction includes an instruction that the path does not pass through a preset stair connection position between the adjacent two floors. In response that the preset stair connection position is in passable state, the controller changes the preset stair connection position as in impassable state. In response that the preset stair connection position is in impassable state, the controller remains the preset stair connection position as impassable state and plans the indoor planned path according to the preset strategy.

Situation four: in response that the controller receives the path operation instruction, and the path operation instruction includes an instruction that the planned path needs to pass through the preset stair connection position between the adjacent two floors. In response that the preset stair connection position is in impassable state, the controller assumes that the preset stair connection position is in passable state and change the connection positions of other passable stairs to impassable stairs, and plans the path according to the preset strategy, and then changes the preset stair connection position between the adjacent two floors on the planned path to a passable state. In response that the stair connection position is in passable state, the controller changes the connection position of other passable stairs to the impassable stairs and plans the path according to the preset strategy.

Situation five: in response that the controller receives the path operation instruction, which comprises an instruction that does not pass through the preset stair connection position between the adjacent two floors; when planning the path, consider the preset stair connection position as an impassable position and planning the path according to the preset strategy.

Situation six: in response that the controller receives the path operation instruction which includes an instruction that needs to pass through a preset stair connection position between the adjacent two floors. The controller sets the preset stair connection position as an intermediate destination position when planning the path and plans the path according to the preset strategy.

Situations three to six, the controller receives the path operation instruction by a user, so that during the robot working, the robot can re-plan a new path if the user adjusts the path halfway.

It can be understood that the controller plans the path from the current position to the target position, the controller needs a single-floor full map or a single-floor partial map of the initial floor, a single-floor full map or a single-floor partial map of the target floor, a single-floor full map or a single-floor partial map of each of the floors between the initial floor and the target floor (exclude the initial floor and the target floor), and the stair connection position of the initial floor, the stair connection position of the target floor, and the stair connection position between each adjacent two floors between the initial floor and the target floor.

In one embodiment, the controller determines whether the target floor and the initial floor are separated by at least one floor in the target building according to an elevation map of the target floor, an elevation map of the initial floor, and an elevation map of each floor between the target floor and the initial floor.

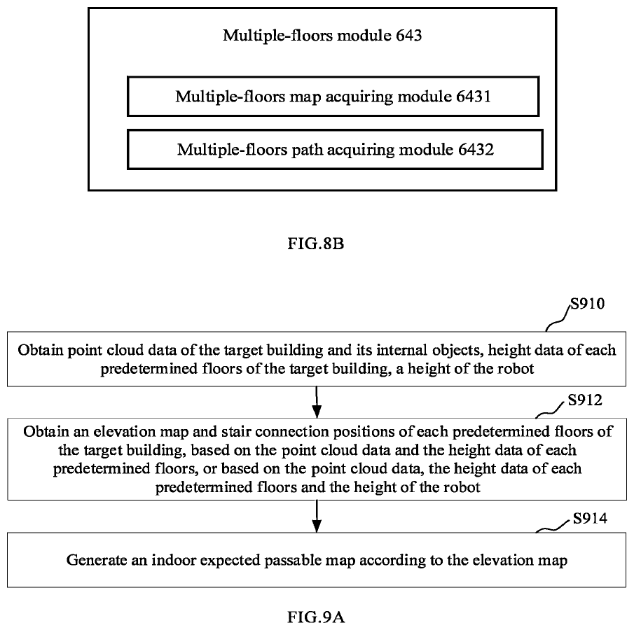

In some embodiments, referring to FIG. 3B, FIG. 4B, FIG. 8A and FIG. 8B, the controller 42 includes a multiple-floors module 423, the controller 64 includes a multiple-floors module 643. The multiple-floors module 423 includes a multiple-floors map acquiring module 4231 and a multiple-floors route acquiring module 4232, the multiple-floors module 643 includes a multiple-floors map acquiring module 6431 and a multiple-floors route acquiring module 6432, the controller obtains the indoor expected passable map in block S40 or blocks S400 and S500 is performed by the multiple-floors map acquiring module 4231 or the multiple-floors map acquiring module 6431. The controller acquires the indoor planned route in block S40 or blocks S400 and S500 is implemented by the multiple-floors route acquiring module 4232 or the multiple-floors route acquiring module 6432.

In one embodiment, the target floor and the initial floor of the robot 100 in the target building are separated by at least one floor in the target building. It can be understood that in the indoor expected passable map, the initial floor and the target floor are separated by at least one floor. Then, the indoor expected passable map includes at least three single-floor maps (single-floor full map or single-floor partial map).

In one embodiment, the single-floor full map may be a single-floor full passable map obtained after the controller making a passable judgment according to the single-floor full elevation map. The controller obtains the single-floor partial map after determining whether the robot can go through according to a single-floor partial elevation map and updates the single-floor partial map as a single-floor partial passable map. In order to save the calculation speed of the passable state, when the robot does not need to pass through the entire area of the floor, the controller can use the single-floor partial passable map of the initial floor, the target floor, or the floors between the initial floor and the target floor.

In one embodiment, the single-floor partial passable map can be the passable map of the stair position area. According to whether the robot moves from the initial position to the target position and only passes through the stair position area, the controller determines whether to obtain the single-floor full passable map or the single-floor partial passable map. In response to the fact that the robot can only pass through the stair position area, the controller obtains the passable map of the stair position of the corresponding floor instead of obtaining a single-floor full map for the calculation of the passable state, thereby speeding up the calculation.

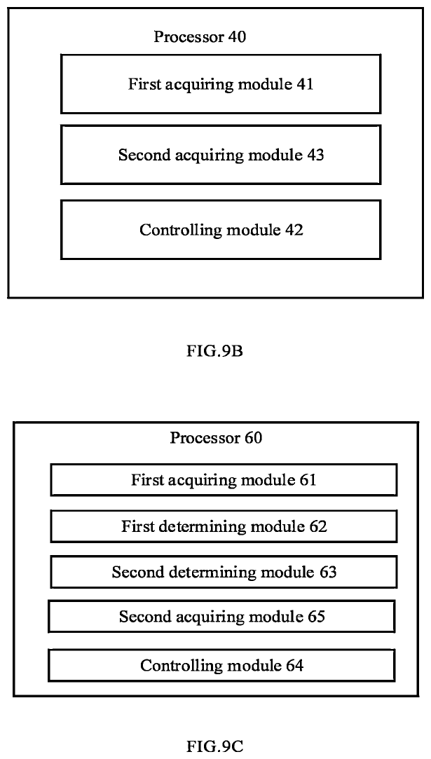

In some embodiments, referring to FIG. 9A, the robot 100 obtains the indoor expected passable map according to the target floor and the initial floor of the target building. The robot control method further includes the following blocks:

Block S910, the robot 100 obtains point cloud data of the target building and its internal objects, height data of each predetermined floors of the target building, a height of the robot 100.

Block S912, the robot 100 obtains an elevation map and stair connection positions of each predetermined floors of the target building, based on the point cloud data and the height data of each predetermined floors, or based on the point cloud data, the height data of each predetermined floors and the height of the robot.

Block S914, the robot 100 generates an indoor expected passable map according to the elevation map. In this way, an indoor expected passable map can be obtained by the robot.

In some embodiments, please refer to FIG. 9B and FIG. 9C, the processor 40 of the robot 100 includes a second acquiring module 43, the processor 60 includes a second acquiring module 65. The second acquiring module 43 of the processor 40 performs the blocks S910-S914. The second acquiring module 65 of the processor 40 performs the blocks S910-S914. That is to say, the second acquiring module 43 and the second acquiring module 65 can acquire point cloud data of the target building and objects in the target building, a height of each floor of predetermined number of floors of the target building, a height of the robot 100, and obtain an elevation map of each floor of predetermined number of floors of the target building, and stair connection position according to the point cloud data, the height of each floor of predetermined number of floors of the target building and the height of the robot based on the elevation map, and obtain the indoor expected passable map according to the elevation map.

In at least one embodiment, the point cloud data includes a set of vectors of a three-dimensional coordinate system. The point cloud data may include not only the three-dimensional coordinates of each point, but also color information, reflection intensity information, etc. The data of the point cloud is not specifically limited here. The point cloud data can be captured by the robot 100 as needed, can also be obtained from pre-stored point cloud data, or can be captured by other devices.

The height data includes a height of each floor of the building. The height data can be obtained by calculating the point cloud data, and the height data can also be obtained by manual setting, which is not specifically limited here. Specifically, the height of each floor of the building may be the same, the height of each floor of the building may also be different, and the height of each floor of the building may be partially the same and partially different.

It is understood that the point cloud data incudes semantic information of stairs, and the semantic information of stairs is marked to indicate the location of the stairs of the point cloud data. Thus, the controller obtains the stair connection position according to the semantic information of the stairs and the height data.

In order to avoid a situation that content of an upper floor of the elevation map covers content of a lower floor, the controller divides the point cloud data into layers to generate an elevation map of each floor. For example, the target building includes two floors, and a height of each floor of the target building is Fh. First, all point cloud data higher than the height Fh are ignored, and the controller generates an elevation map of the first floor based on the remaining point cloud data, and generates the indoor passable map corresponding to the first floor according to the elevation map. Then the controller uses the point cloud data higher than the height Fh, and generates an elevation map of the second floor based on the point cloud data higher than the height Fh, and the indoor passable map corresponding to the second floor according to the elevation map.

In addition to the need to divide the point cloud data by floor, when the controller generates the elevation map according to floor dividing, the expected passable map may cause inaccuracies as higher objects cover lower objects in the floor. For example, there are chandeliers on the ceiling, in the process of the controller generates the elevation map, the elevation map of the area where the chandelier is located shows that the height of the area reaches the ceiling, and the indoor expected passable map thus generated shows that the area with the chandelier cannot pass, but in fact the robot 100 can pass under the chandelier. Therefore, in the process of generating the elevation map, in order to prevent the objects on the ceiling from affecting the accuracy of the generated passable map, the elevation map can be divided according to the data of the low height of the objects on the ceiling.

In addition, when the cutting line for dividing the elevation map is too low, for example, lower than a maximum height of the robot, the impassable objects may be processed as passable objects. The controller may use the height of the floor, or the height of the robot, or a height between the ceiling and the robot as the height for dividing the elevation map of each layer. The controller can divide the elevation map in real time, and then the corresponding passable map can be calculated in real time according to the divided elevation map. The height of the robot is variable. The height of the robot is equal to a highest body height when the robot moves. The body height is equal to a height from the lowest position of the robot body to the highest position of the body. For example, the robot can move upright, squats down, or crawls. The highest body height is obtained when the robot moves upright. In one embodiment, when the robot is unloaded or not equipped with a mechanical arm, the height of the robot is equal to a highest body height when the robot moves. In one embodiment, when the robot is loaded or equipped with a mechanical arm, and the height of the robot is equal to a height of the robot body or equal to a height from a lowest position of the robot body to a highest position of the loaded object or equal to a height from the lowest position of the robot body to the highest position of the mechanical arm.

In one embodiment, when the elevation map is divided by the height of the robot, when the robot 100 is passing, the position higher than the height of the robot 100 will not affect the robot, so that the data of the point cloud exceeding the height of the robot 100 can be discarded, and the data of the point cloud lower than the height of the robot 100 can be used to generate the elevation map. Specifically, when the cutting line used to generate the elevation map is lower than the highest height of the robot 100, the impassable obstacles may be processed into passable obstacles, and the passable obstacles may be processed into impassable obstacles. of obstacles. When the cutting line is much lower than the maximum height of the robot, the cabinet may be treated as a passable obstacle, but it is actually an impassable obstacle. It can be understood that the cutting line is used to divide the layer height data together with the point cloud data used to generate the elevation map, and the cutting line is determined according to the height data of the robot 100. For the convenience of understanding, an example is given below. In one embodiment, the height of the robot 100 is 1 meter. The height of each floor is 3 meters, when objects hanging on the ceiling are considered, the floor can be divided according to 2.5 meters. An elevation map of a first floor can be generated from a height of 0 meters compared with the ground to 2.5 meters. An elevation map of a second floor can be generated from a height of 2.5 meters to 5.5 meters. An elevation map of a third floor can be generated from a height of 5.5 meters to 8.5 meters.

It is noted that in some embodiments, the robot 100 can not only walk upright, but also squat down, walk, crawl, etc., and there may be suspended obstacles such as tables in the target building. A lowest moving height of the robot 100 can be considered when the controller generating the elevation map. The lowest moving height is equal to a height of the path that the robot 100 can pass through. For a suspended object, the cutting line for generating the elevation map may be set higher than the minimum moving height of the robot 100. Specifically, when the obstacle is higher than the lowest moving height of the robot 100, but shorter than the height of the robot 100, the robot 100 can pass by squatting, walking, crawling, etc., and when the obstacle is higher than the height of the robot 100, the robot is able to walk upright normally.

It is worth noting that since the floor may have locations with different heights such as slopes and stairs, the height of the floor can be determined according to the point cloud data, and then the height of the robot 100 or the movement of the robot 100 can be added to the height of the floor. The lowest moving height is used as the cutting line for generating the elevation map, the point cloud data below the cutting line generates the elevation map, and the point cloud data above the cutting line is ignored.

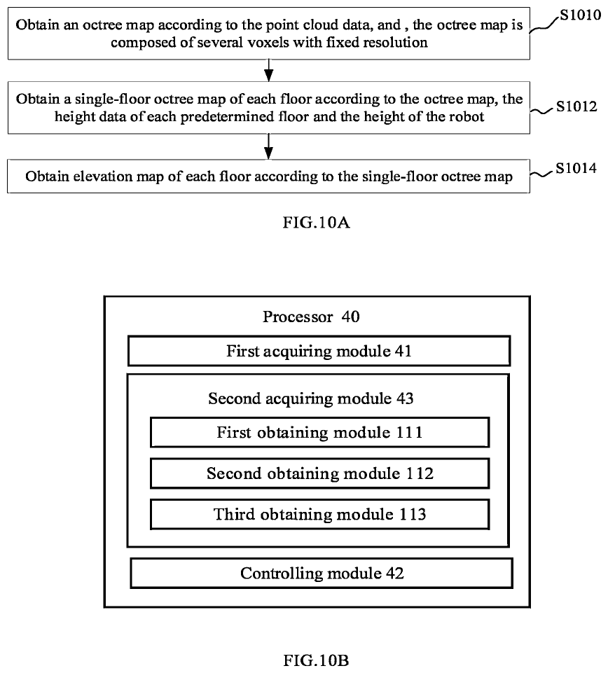

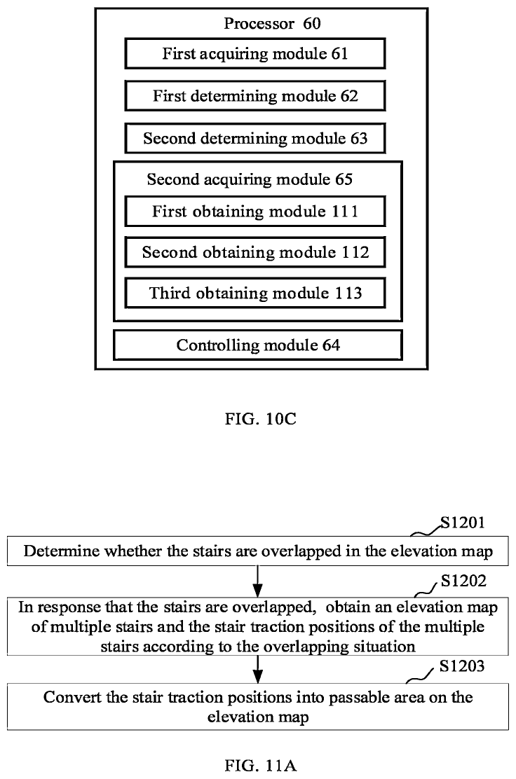

In some embodiments, please refer to FIG. 10A, block S912 includes:

Block S1010, the robot 100 obtains an octree map according to the point cloud data, and, the octree map is composed of several voxels with fixed resolution.

Block S1012, the robot 100 obtains a single-floor octree map of each floor according to the octree map, the height data of each predetermined floor and the height of the robot 100.

Block S1014, the robot 100 obtains elevation map of each floor according to the single-floor octree map.

In at least one embodiment, the octree map generated from the point cloud data can effectively reduce the excessive repetitive data information of the point cloud data, thereby obtaining the elevation map according to the octree map, effectively reducing the amount of calculation, and speeding up the time to obtain the elevation map.

In some embodiments, please refer to FIG. 10B and FIG. 10C, Blocks S1010 to S1014 can be implemented by the second acquiring module 43 in the processor 40 of the robot 100 or the second acquiring module 65 in the processor 60. The second acquiring module 43 or the second acquiring module 65 includes a first obtaining module 111, a second obtaining module 112 and a third obtaining module 113. The first obtaining module 111 is used to obtain an octree map according to the point cloud data, and the octree map includes several voxels with fixed resolutions. The second obtaining module 112 is used to obtain a single-floor octree map of each floor according to the octree map, the height of the floor and the height of the robot 100. The third obtaining module 113 is used to obtain the elevation map of each floor according to the single-floor octree map.

In at least one embodiment, the fixed resolution of a voxel can be 2 cm, 3 cm, 5 cm, etc. That is, a voxel can be composed of a cube with a side length of 2 cm, a voxel can be composed of a cube with a side length of 3 cm, and a voxel can be composed of a cube with a side length of 5 cm. The smaller the fixed resolution value of the voxel, the finer the octree map, the larger the fixed resolution value of the voxel, the smaller the calculation amount and the faster the conversion speed of the octree map into the elevation map. The value of the resolution can be adjusted according to factors such as the volume of the robot 100 and the complexity of the internal layout of the building and is not specifically limited here. The position of each voxel in the octree map can be represented by a spatial point (x1, y1, z1), where x1, y1, z1 are variables, which are adjusted according to the specific position of each voxel. A unit of x1, y1 and z1 can be adjusted according to the size of the space and the size of the robot 100. It is worth noting that some areas in the octree map have voxels, and some areas do not have voxels, so as to avoid excessive duplication of data.

In some embodiments, a resolution of the elevation map is equal to a resolution of the octree map. In this way, the controller can conveniently convert the octree map into an elevation map, reducing the amount of calculation for obtaining the elevation map. Specifically, the elevation map can include several grids, and the position of the grids in the octree map can be represented by a spatial point (x2, y2, z2), where x2, y2, z2 are variables, which are based on each volume. The position of the pixel can be adjusted, and the units of x2, y2, and z2 can be adjusted according to the size of the space and the size of the robot 100. The height value z2 of each grid may correspond to the maximum z1 value in each voxel of the octree map at the same (x2, y2) position. For the convenience of understanding, an example is given below. In one embodiment, the height of the grid of the elevation map is unknown, x2=1, y2=1 of the grid, in the octree map, there are three voxels with x1=1, y1=1. The spatial points of the three voxels are respectively (1,1,1), (1, 1, 2) and (1, 1, 3), and the grid spatial points of the elevation map are (1, 1, 3). In this way, objects with a certain height, such as tables, chairs, and cabinets placed in buildings, need to be represented by several voxels. When the controller generates an elevation map, only the voxel with the highest height needs to be considered, then the heights of the tables, chairs, and cabinets are obtained to generate the elevation map.

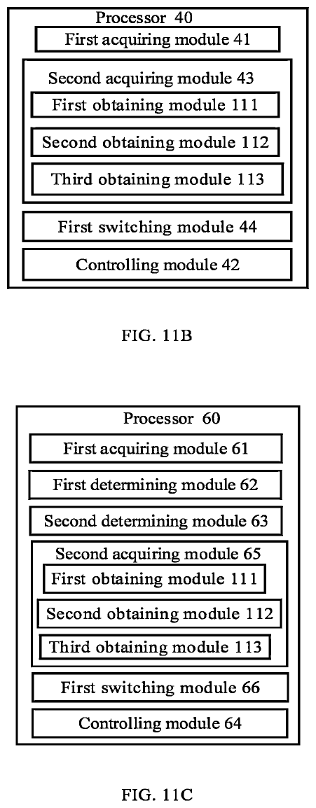

In some implementations, please refer to FIG. 11A, after obtaining the elevation map of each floor of the predetermined number of floors and the stair connection positions, the robot controlling method further includes:

Block S1201, the robot 100 determines whether the stairs are overlapped in the elevation map.

Block S1202, in response that the stairs are overlapped, the robot 100 obtains an elevation map of multiple stairs and the stair traction positions of the multiple stairs according to the overlapping situation.

Block S1203, the robot 100 converts the stair traction positions into passable state on the elevation map.

In this way, the problem of inaccurate elevation maps caused by the overlapping of stairs can be avoided, thereby providing a basis for generating a more accurate passable map of the stair location area.

In some embodiments, please refer to FIG. 11B and FIG. 11C, the processor 40 of the robot 100 includes a first switching module 44, and the processor 60 includes a first switching module 66, the above blocks can be performed by the first switching module of the processor 40, or the first switching module 66 of the processor 60.

The stair traction position can be the connection position between two adjacent stairs. When generating the elevation map of multiple stairs, the two sides of each stair may be impassable. In fact, the two sides or one side of each stair are possible to pass to the adjacent stairs or the ground, so the area near the stair traction position in the elevation map can be set as the passable state according to the stair traction position.

In one embodiment, the stair is spiral. At the same position of the stair, if there are three overlapping stairs, the stairs can be divided into three sections so that there is no overlapping stair on each section. The connection position of adjacent stairs is marked as the stair traction position, and the elevation maps of multiple stairs are stitched together to generate the stair elevation map, which provides a basis for generating the passable map of the stair location area.

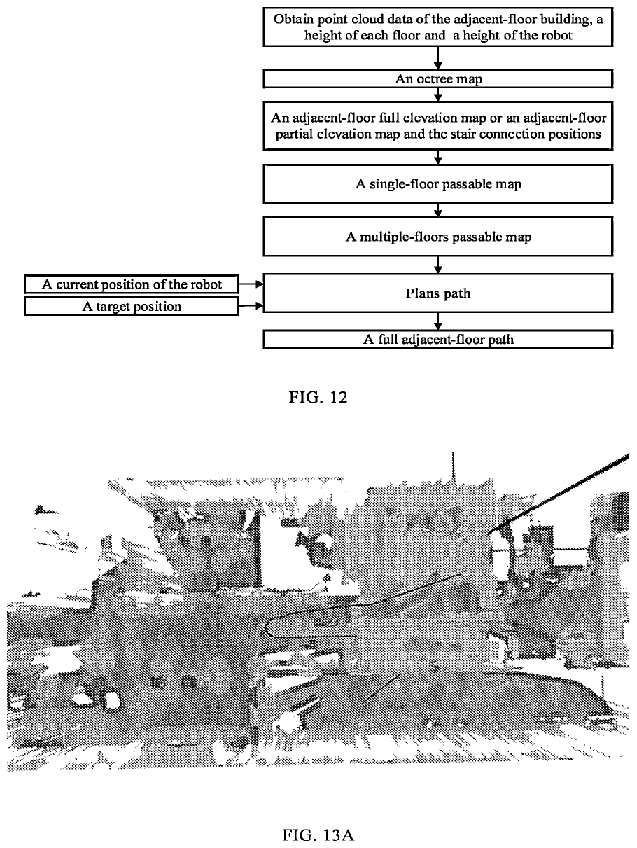

In one embodiment, please refer to FIG. 12, FIG. 13A and FIG. 13B, the target building includes two floors (adjacent-floor building), and the robot controlling method includes: the controller obtains point cloud data of the adjacent-floor building, a height of each floor and a height of the robot 100, and obtains an octree map based on the point cloud data of the target building, and obtains an adjacent-floor full elevation map or an adjacent-floor partial elevation map and the stair connection positions according to the octree map, and obtains a single-floor passable map based on the adjacent-floor full elevation map or the adjacent-floor partial elevation map, and obtains a multi-floor passable map based on the single-floor passable map and the positions of the stair connection. The controller receives a current position of the robot 100 and a target position input by a user, and generates a full adjacent-floor path according to the multi-floor passable map and the current position and the target position.

It is worth noting that in the process of generating a passable map, the information on the ground mainly affects the robot to pass. In fact, the information on the upper of the floor, such as ceilings, chandeliers, etc., can be ignored, so the robot of this embodiment can plan 2.5D paths.

Specifically, FIG. 13A is a top view of path planned by the robot provided by an embodiment of the present disclosure, and FIG. 13B is a side view of path planned by the robot provided by an embodiment of the present disclosure.

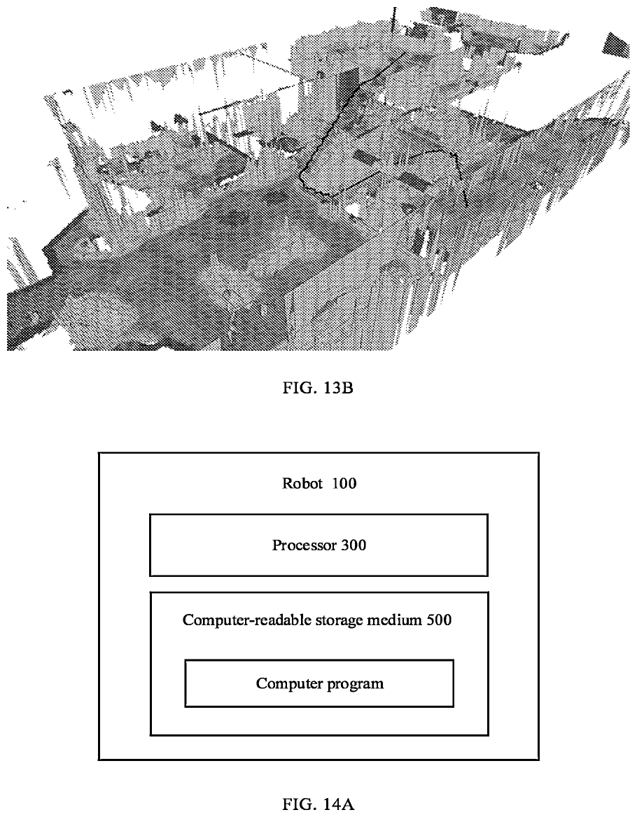

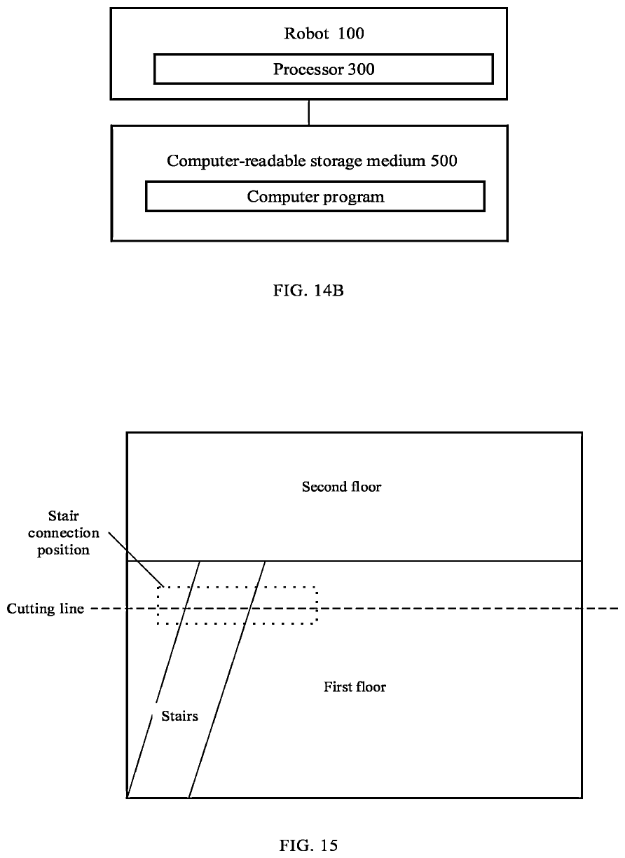

Referring to FIG. 14A and FIG. 14B, the robot 100 according to the embodiment of the present disclosure includes a computer-readable storage medium 500, a processor 300, and a computer program stored in the computer-readable storage medium 500 and operable on the processor 300, the processor 300 realizes the control method of the robot 100 according to the embodiment of the present disclosure when executing the computer program. In this way, the control method of the robot 100 in the embodiment of the present disclosure can be realized by the robot 100 in the embodiment of the present disclosure, wherein all the above steps can be realized by the processor 300.

In one embodiment, the at least one processor 300 may include a driver board, and the driver board may include a Central Processing Unit (CPU), and may also include other general purpose processors, Digital Signal Processor (DSP), Application Specific Integrated Circuit (ASIC), or other volatile solid state memory devices, Integrated Circuit (ASIC), Field-Programmable Gate Array (FPGA) or other programmable logic device, discrete gate or transistor logic device, discrete hardware component, etc.

It should be noted that the computer program stored in the computer-readable storage medium 500 in the embodiment of the present disclosure can be executed by the processor 300 of the robot 100. It should be noted that the computer-readable storage medium 500 can be a storage device built in the robot 100. The computer-readable storage medium 500, as shown in FIG. 14A, may also be a storage medium 500 that can be plugged into the robot 100, as shown in FIG. 14B. Therefore, the computer-readable storage medium 500 in the embodiment of the present disclosure has high flexibility and reliability.

In the description of the present disclosure, descriptions with reference to the terms “one embodiment”, “some embodiments”, “exemplary embodiments”, “example”, “specific examples” or “some examples” mean that a combination of the embodiments or examples describe specific features, structures, materials, or characteristics that are included in at least one embodiment or example of the present disclosure. In the present disclosure, schematic representations of the above terms do not necessarily refer to the same embodiment or example. Furthermore, the described specific features, structures, materials or characteristics may be combined in any manner in any one or more embodiments or examples.

The logic and/or blocks represented in the flowcharts or otherwise described herein. For example, the logic and/or blocks may be considered as a sequenced list of executable instructions for implementing logical functions and may be embodied in any computer-readable medium for use by an instruction execution system, apparatus, or device, or used in conjunction with these instruction execution systems, devices or equipment. Such as computer-based systems, systems including processing modules, or other systems that can fetch and execute instructions from an instruction execution system, apparatus, or device. For the purposes of the present disclosure, a “computer-readable medium” may be any device that can contain, store, communicate, propagate or transmit a program for use or in conjunction with an instruction execution system, or device. More specific examples (non-exhaustive list) of computer-readable media include the following: electrical connection with one or more wires (electronic device), portable computer disk case (magnetic device), random access memory (RAM), Read Only Memory (ROM), Erasable and Editable Read Only Memory (EPROM or Flash Memory), Fiber Optic Devices, and Portable Compact Disc Read Only Memory (CDROM). In addition, the computer-readable medium may even be paper or other medium on which the program may be printed, as it may be possible, for example, by optically scanning the paper or other medium, followed by editing, interpretation or other means if necessary. The program is obtained electronically by processing and then stored in computer memory 200.

The processor 300 may be a central processing unit (Central Processing Unit, CPU), and may also be other general-purpose processors 300, a digital signal processor 300 (Digital Signal Processor, DSP), an application specific integrated circuit (Application Specific Integrated Circuit, ASIC), Ready-made programmable gate array (Field-Programmable Gate Array, FPGA) or other programmable logic devices, discrete gate or transistor logic devices, discrete hardware components, etc. The general-purpose processor 300 may be a microprocessor 300 or the processor 300 may be any conventional processor 300 or the like.

It is understood that each part of the embodiments of the present disclosure may be realized by hardware, software, firmware or a combination thereof. In the embodiments described above, the blocks or the robot controlling method may be implemented by software or firmware stored in the storage device and executed by an instruction execution system. For example, if implemented in hardware, as in another embodiment, it can be implemented by any one or combination of the following techniques known in the art: Discrete logic circuits, ASICs with combinational logic gates, programmable gate arrays (PGAs), field programmable gate arrays (FPGAs), etc.

Those of ordinary skill in the art can understand that all or part of the steps carried by the method of the above-mentioned embodiments can be completed by instructing related hardware through a program, and the program can be stored in a computer-readable storage medium 500, and the program can be executed when the program is executed. When, one or a combination of the steps of the method embodiment is included.

The storage medium mentioned above may be a read-only memory, a magnetic disk or an optical disk, and the like.

Although the embodiments of the present disclosure have been shown and described above, it can be understood that the above embodiments are exemplary and should not be construed as limitations on the present disclosure. The embodiments are subject to changes, modifications, substitutions and variations.

It is understood that the division of modules described above is a logical functional division, and there can be another division in actual implementation. In addition, each functional module in each embodiment of the present disclosure may be integrated in the same processing unit, or each module may physically exist separately, or two or more modules may be integrated in the same unit. The above integrated modules can be implemented either in the form of hardware or in the form of hardware plus software functional modules. The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A robot controlling method, the method comprising:
obtaining a target position and a current position of a robot;
obtaining a target floor of a target building according to the target position;
obtaining an initial floor of the target building according to the current position of the robot;
generating an indoor expected passable map according to the target floor and the initial floor;
generating an indoor planned path according to the indoor expected passable map, the current position, and the target position; and
controlling the robot to move according to the indoor planned path.

2. The robot controlling method according to claim 1, wherein the method further comprises:
determining whether the target position is inside the target building according to the target position and a position of the target building;
obtaining a target floor of the robot in the target building;
responsive to that the target position is inside the target building, determining that the target floor of the robot in the target building is a floor where the target position is located;
responsive to that the target position is outside the target building, determining that the target floor of the robot in the target building is a floor where the robot leaves the target building;
determining whether the current position of the robot is inside the target building according to the current position of the robot and a position of the target building;
obtaining an initial floor of the robot in the target building;
responsive to that the current position of the robot is inside the target building, determining that the initial floor of the robot in the target building is a floor where the current position of the robot is located;
responsive to that the current position of the robot is outside the target building, determining that the initial floor of the robot in the target building is a floor where the robot enters the target building;
responsive to that the target position and the current position of the robot are inside the target building, generating an indoor expected passable map according to the target floor and the initial floor of the robot and generating an indoor planned path according to the indoor expected passable map, the current position, and the target position;
controlling the robot to move according to the indoor planned path;
responsive to that the target position is outside the target building or the current position of the robot is outside the target building, generating an indoor expected passable map and an outdoor expected passable map;
generating an indoor planned path and an outdoor planned path according to the indoor expected passable map, the outdoor expected passable map, the current position, and the target position; and
controlling the robot to move according to the indoor planned path and the outdoor planned path.

3. The robot controlling method according to claim 2, wherein responsive to that the target floor and the initial floor are two adjacent floors of the target building, generating an indoor expected passable map according to the target floor and the initial floor of the robot further comprises:
acquiring a single-floor full map of the initial floor or acquiring a single-floor partial map of the initial floor according to the current position;
acquiring a single-floor full map of the target floor or a single-floor partial map of the target floor according to the target position;
obtaining a plurality of stair connection positions between the adjacent two floors; and
obtaining the indoor expected passable map according to the single-floor full map or partial map of the initial floor, the single-floor full map or partial map of the current floor and the plurality of stair connection positions.

4. The robot controlling method according to claim 3, wherein generating an indoor planned path comprises:
responsive to that the stair connection positions between adjacent two floors are all in impassable state, and receiving no path operation instruction, planning the path according to a preset strategy after changing at least one of the stair connection positions between adjacent two floors to a passable state; and
responsive to that the stair connection positions between adjacent two floors are all in impassable state and receiving no path operation instruction, planning the path according to the preset strategy after assuming all the stair connection positions are in passable state, and changing the stair connection positions between the adjacent two floors on the planned path to passable stat; and
receiving a path operation instruction, which comprise an instruction that do not pass through a preset stair connection position between the adjacent two floors; and responsive to that the preset stair connection position is in passable state, changing the preset stair connection position to impassable state and planning the path according to the preset strategy; and responsive to that the preset stair connection position is in impassable state, then maintaining the impassable state and planning the path according to the preset strategy; and
receiving a path operation instruction, which comprises an instruction that needs to pass through a preset stair connection position between the adjacent two floors; and responsive to that the preset stair connection position is in impassable state, assuming the preset stair connection position is in passable state and changing the connection positions of other passable stairs to impassable stairs, and planning the path according to the preset strategy, then changing the preset stair connection position between the adjacent two floors on the planned path to a passable position; responsive to that the preset stair connection position is in passable state, changing the connection position of other passable stairs to impassable stairs and planning the path according to the preset strategy; and
receiving the path operation instruction, which comprises an instruction that does not pass through the preset stair connection position between the adjacent two floors; when planning the path, consider the preset stair connection position as an impassable position and planning the path according to the preset strategy; and
receiving the path operation instruction, which comprises an instruction that needs to pass through a preset stair connection position between the adjacent two floors, when planning the path, setting the preset stair connection position as an intermediate destination position and planning the path according to the preset strategy.

5. The robot controlling method according to claim 2, wherein responsive to that the target floor and the initial floor of the robot in the target building are separated by at least one floor in the target building, generating an indoor expected passable map according to the target floor and the initial floor of the robot further comprises:
obtaining a single-floor full map of the initial floor or obtaining a single-floor partial map of the initial floor based on the current position;
obtaining a single-floor full map of the target floor or obtaining a single-floor partial map of the target floor according to the target position;
obtaining a single-floor full map or a single-floor partial map of each floor between the initial floor and the target floor;
obtaining a plurality of stair connection positions between the adjacent two floors from the initial floor, the target floor, and the floors between the initial floor and the target floor;
generating the indoor expected passable map according to the single-floor full map of the initial floor or the single-floor partial map of the initial floor, the single-floor full map of the target floor or the single-floor partial map of the target floor, the single-floor full map or partial map of the floor between the initial floor and the target floor, and a plurality of stair connection positions between the adjacent two floors from the initial floor, the target floor, and the floors between the initial floor and the target floor.

6. The robot controlling method according to claim 5, wherein generating an indoor planned path comprises:
responsive to that the stair connection positions between adjacent two floors are all in impassable state, and receiving no path operation instruction, planning the path according to a preset strategy after changing at least one of the stair connection positions between adjacent two floors to a passable state and
responsive to that the stair connection positions between adjacent two floors are all in impassable state and receiving no path operation instruction, planning the path according to the preset strategy after assuming all the stair connection positions are in passable state, and changing the stair connection positions between the adjacent two floors on the planned path to passable stat; and
receiving a path operation instruction, which comprise an instruction that do not pass through a preset stair connection position between the adjacent two floors; and responsive to that the preset stair connection position is in passable state, changing the preset stair connection position to impassable state and planning the path according to the preset strategy; and responsive to that the preset stair connection position is in impassable state, then maintaining the impassable state and planning the path according to the preset strategy; and
receiving a path operation instruction, which comprises an instruction that needs to pass through a preset stair connection position between the adjacent two floors; and responsive to that the preset stair connection position is in impassable state, assuming the preset stair connection position is in passable state and changing the connection positions of other passable stairs to impassable stairs, and planning the path according to the preset strategy, then changing the preset stair connection position between the adjacent two floors on the planned path to a passable position; responsive to that the preset stair connection position is in passable state, changing the connection position of other passable stairs to impassable stairs and planning the path according to the preset strategy; and
receiving the path operation instruction, which comprises an instruction that does not pass through the preset stair connection position between the adjacent two floors; when planning the path, consider the preset stair connection position as an impassable position and planning the path according to the preset strategy; and
receiving the path operation instruction, which comprises an instruction that needs to pass through a preset stair connection position between the adjacent two floors, when planning the path, setting the preset stair connection position as an intermediate destination position and planning the path according to the preset strategy.

7. The robot controlling method according to claim 1, wherein before generating an indoor expected passable map, the method further comprises:
obtaining point cloud data of the target building and its internal objects, height data of each predetermined floors of the target building, a height of the robot;
obtaining an elevation map and stair connection positions of each predetermined floors of the target building, based on the point cloud data and the height data of each predetermined floors, or based on the point cloud data, the height data of each predetermined floors and the height of the robot; and
generating the indoor expected passable map according to the elevation map.

8. The robot controlling method according to claim 7, wherein obtaining an elevation map of each predetermined floors of the target building, based on the point cloud data, the height data of each predetermined floors and the height of the robot comprises:
obtaining an octree map according to the point cloud data, the octree map is composed of several voxels with fixed resolution;
obtaining a single-floor octree map of each floor according to the octree map, the height data of each predetermined floors and the height of the robot; and
obtaining elevation map of each floor according to the single-floor octree map.

9. A robot comprising:
a body;
two or more legs coupled to the body;
at least one processor in communication with the two or more legs;
a storage device in communication with the at least one processor, the storage device storing instructions, that when executed by the at least one processor, cause the at least one processor to perform operations comprising:
obtaining a target position and a current position of a robot;
obtaining a target floor of a target building according to the target position;
obtaining an initial floor of the target building according to the current position of the robot;
generating an indoor expected passable map according to the target floor and the initial floor;
generating an indoor planned path according to the indoor expected passable map, the current position, and the target position; and
controlling the robot to move according to the indoor planned path.

10. The robot according to claim 9, wherein the operations further comprise:
determining whether the target position is inside the target building according to the target position and a position of the target building;
obtaining a target floor of the robot in the target building;
responsive to that the target position is inside the target building, determining that the target floor of the robot in the target building is a floor where the target position is located;
responsive to that the target position is outside the target building, determining that the target floor of the robot in the target building is a floor where the robot leaves the target building;
determining whether the current position of the robot is inside the target building according to the current position of the robot and a position of the target building;
obtaining an initial floor of the robot in the target building;
responsive to that the current position of the robot is inside the target building, determining that the initial floor of the robot in the target building is a floor where the current position of the robot is located;
responsive to that the current position of the robot is outside the target building, determining that the initial floor of the robot in the target building is a floor where the robot enters the target building;
responsive to that the target position and the current position of the robot are inside the target building, generating an indoor expected passable map according to the target floor and the initial floor of the robot and generating an indoor planned path according to the indoor expected passable map, the current position, and the target position;
controlling the robot to move according to the indoor planned path;
responsive to that the target position is outside the target building or the current position of the robot is outside the target building, generating an indoor expected passable map and an outdoor expected passable map;
generating an indoor planned path and an outdoor planned path according to the indoor expected passable map, the outdoor expected passable map, the current position, and the target position; and
controlling the robot to move according to the indoor planned path and the outdoor planned path.

11. The robot according to claim 10, wherein responsive to that the target floor and the initial floor are two adjacent floors of the target building, the at least one processor generates an indoor expected passable map according to the target floor and the initial floor of the robot by:
acquiring a single-floor full map of the initial floor or acquiring a single-floor partial map of the initial floor according to the current position;
acquiring a single-floor full map of the target floor or a single-floor partial map of the target floor according to the target position;
obtaining a plurality of stair connection positions between the adjacent two floors; and
obtaining the indoor expected passable map according to the single-floor full map or partial map of the initial floor, the single-floor full map or partial map of the current floor and the plurality of stair connection positions.

12. The robot according to claim 11, wherein the at least one processor generates an indoor planned path by:
responsive to that the stair connection positions between adjacent two floors are all in impassable state, and receiving no path operation instruction, planning the path according to a preset strategy after changing at least one of the stair connection positions between adjacent two floors to a passable state; and
responsive to that the stair connection positions between adjacent two floors are all in impassable state and receiving no path operation instruction, planning the path according to the preset strategy after assuming all the stair connection positions are in passable state, and changing the stair connection positions between the adjacent two floors on the planned path to passable stat; and
receiving a path operation instruction, which comprise an instruction that do not pass through a preset stair connection position between the adjacent two floors; and responsive to that the preset stair connection position is in passable state, changing the preset stair connection position to impassable state and planning the path according to the preset strategy; and responsive to that the preset stair connection position is in impassable state, then maintaining the impassable state and planning the path according to the preset strategy; and
receiving a path operation instruction, which comprises an instruction that needs to pass through a preset stair connection position between the adjacent two floors; and responsive to that the preset stair connection position is in impassable state, assuming the preset stair connection position is in passable state and changing the connection positions of other passable stairs to impassable stairs, and planning the path according to the preset strategy, then changing the preset stair connection position between the adjacent two floors on the planned path to a passable position; responsive to that the preset stair connection position is in passable state, changing the connection position of other passable stairs to impassable stairs and planning the path according to the preset strategy; and
receiving the path operation instruction, which comprises an instruction that does not pass through the preset stair connection position between the adjacent two floors; when planning the path, consider the preset stair connection position as an impassable position and planning the path according to the preset strategy; and
receiving the path operation instruction, which comprises an instruction that needs to pass through a preset stair connection position between the adjacent two floors, when planning the path, setting the preset stair connection position as an intermediate destination position and planning the path according to the preset strategy.

13. The robot according to claim 10, wherein responsive to that the target floor and the initial floor of the robot in the target building are separated by at least one floor in the target building, the at least one processor generates an indoor expected passable map according to the target floor and the initial floor of the robot by:
obtaining a single-floor full map of the initial floor or obtaining a single-floor partial map of the initial floor based on the current position;
obtaining a single-floor full map of the target floor or obtaining a single-floor partial map of the target floor according to the target position;
obtaining a single-floor full map or a single-floor partial map of each floor between the initial floor and the target floor;
obtaining a plurality of stair connection positions between the adjacent two floors from the initial floor, the target floor, and the floors between the initial floor and the target floor;
generating the indoor expected passable map according to the single-floor full map of the initial floor or the single-floor partial map of the initial floor, the single-floor full map of the target floor or the single-floor partial map of the target floor, the single-floor full map or partial map of the floor between the initial floor and the target floor, and a plurality of stair connection positions between the adjacent two floors from the initial floor, the target floor, and the floors between the initial floor and the target floor.

14. The robot according to claim 13, wherein the at least one processor generates an indoor planned path by:
responsive to that the stair connection positions between adjacent two floors are all in impassable state, and receiving no path operation instruction, planning the path according to a preset strategy after changing at least one of the stair connection positions between adjacent two floors to a passable state; and
responsive to that the stair connection positions between adjacent two floors are all in impassable state and receiving no path operation instruction, planning the path according to the preset strategy after assuming all the stair connection positions are in passable state, and changing the stair connection positions between the adjacent two floors on the planned path to passable stat; and
receiving a path operation instruction, which comprise an instruction that do not pass through a preset stair connection position between the adjacent two floors; and responsive to that the preset stair connection position is in passable state, changing the preset stair connection position to impassable state and planning the path according to the preset strategy; and responsive to that the preset stair connection position is in impassable state, then maintaining the impassable state and planning the path according to the preset strategy; and
receiving a path operation instruction, which comprises an instruction that needs to pass through a preset stair connection position between the adjacent two floors; and responsive to that the preset stair connection position is in impassable state, assuming the preset stair connection position is in passable state and changing the connection positions of other passable stairs to impassable stairs, and planning the path according to the preset strategy, then changing the preset stair connection position between the adjacent two floors on the planned path to a passable position; responsive to that the preset stair connection position is in passable state, changing the connection position of other passable stairs to impassable stairs and planning the path according to the preset strategy; and
receiving the path operation instruction, which comprises an instruction that does not pass through the preset stair connection position between the adjacent two floors; when planning the path, consider the preset stair connection position as an impassable position and planning the path according to the preset strategy; and
receiving the path operation instruction, which comprises an instruction that needs to pass through a preset stair connection position between the adjacent two floors, when planning the path, setting the preset stair connection position as an intermediate destination position and planning the path according to the preset strategy.

15. The robot according to claim 9, wherein before generating an indoor expected passable map, the at least one processor is further caused to perform operations comprising:
obtaining point cloud data of the target building and its internal objects, height data of each predetermined floors of the target building, a height of the robot;
obtaining an elevation map and stair connection positions of each predetermined floors of the target building, based on the point cloud data and the height data of each predetermined floors, or based on the point cloud data, the height data of each predetermined floors and the height of the robot; and
generating the indoor expected passable map according to the elevation map.

16. The robot according to claim 15, wherein the at least one processor obtains an elevation map of each predetermined floors of the target building, based on the point cloud data, the height data of each predetermined floors and the height of the robot by:
obtaining an octree map according to the point cloud data, the octree map is composed of several voxels with fixed resolution;
obtaining a single-floor octree map of each floor according to the octree map, the height data of each predetermined floors and the height of the robot; and
obtaining elevation map of each floor according to the single-floor octree map.

17. A non-transitory storage medium having instructions stored thereon, when the instructions are executed by a processor of a robot, the processor is caused to perform a robot controlling method, wherein the method comprises:
obtaining a target position and a current position of a robot;
obtaining a target floor of a target building according to the target position;
obtaining an initial floor of the target building according to the current position of the robot;
generating an indoor expected passable map according to the target floor and the initial floor;
generating an indoor planned path according to the indoor expected passable map, the current position, and the target position; and
controlling the robot to move according to the indoor planned path.

18. The non-transitory storage medium according to claim 17, wherein the method further comprises:
determining whether the target position is inside the target building according to the target position and a position of the target building;
obtaining a target floor of the robot in the target building;
determining that the target floor of the robot in the target building is a floor where the target position is located in response that the target position is inside the target building;
responsive to that the target position is outside the target building, determining that the target floor of the robot in the target building is a floor where the robot leaves the target building;
determining whether the current position of the robot is inside the target building according to the current position of the robot and a position of the target building;
obtaining an initial floor of the robot in the target building;
responsive to that the current position of the robot is inside the target building, determining that the initial floor of the robot in the target building is a floor where the current position of the robot is located;
responsive to that the current position of the robot is outside the target building, determining that the initial floor of the robot in the target building is a floor where the robot enters the target building;
generating an indoor expected passable map according to the target floor and the initial floor of the robot in response that the target position and the current position of the robot are inside the target building and generating an indoor planned path according to the indoor expected passable map, the current position, and the target position;
controlling the robot to move according to the indoor planned path;
generating an indoor expected passable map and an outdoor expected passable map in response that the target position is outside the target building or the current position of the robot is outside the target building;
generating an indoor planned path and an outdoor planned path according to the indoor expected passable map, the outdoor expected passable map, the current position, and the target position; and
controlling the robot to move according to the indoor planned path and the outdoor planned path.

19. The non-transitory storage medium according to claim 18, wherein responsive to that the target floor and the initial floor are of the target building, generating an indoor expected passable map according to the target floor and the initial floor of the robot further comprises:
acquiring a single-floor full map of the initial floor or acquiring a single-floor partial map of the initial floor according to the current position;
acquiring a single-floor full map of the target floor or a single-floor partial map of the target floor according to the target position;
obtaining a plurality of stair connection positions between the adjacent two floors; and
obtaining the indoor expected passable map according to the single-floor full map or partial map of the initial floor, the single-floor full map or partial map of the current floor and the plurality of stair connection positions;
wherein generating an indoor planned path comprises:
responsive to that the stair connection positions between adjacent two floors are all in impassable state, and receiving no path operation instruction, planning the path according to a preset strategy after changing at least one of the stair connection positions between adjacent two floors to a passable state; and
responsive to that the stair connection positions between adjacent two floors are all in impassable state and receiving no path operation instruction, planning the path according to the preset strategy after assuming all the stair connection positions are in passable state, and changing the stair connection positions between the adjacent two floors on the planned path to passable stat; and
receiving a path operation instruction, which comprise an instruction that do not pass through a preset stair connection position between the adjacent two floors; and responsive to that the preset stair connection position is in passable state, changing the preset stair connection position to impassable state and planning the path according to the preset strategy; and responsive to that the preset stair connection position is in impassable state, then maintaining the impassable state and planning the path according to the preset strategy; and
receiving a path operation instruction, which comprises an instruction that needs to pass through a preset stair connection position between the adjacent two floors; and responsive to that the preset stair connection position is in impassable state, assuming the preset stair connection position is in passable state and changing the connection positions of other passable stairs to impassable stairs, and planning the path according to the preset strategy, then changing the preset stair connection position between the adjacent two floors on the planned path to a passable position; responsive to that the preset stair connection position is in passable state, changing the connection position of other passable stairs to impassable stairs and planning the path according to the preset strategy; and
receiving the path operation instruction, which comprises an instruction that does not pass through the preset stair connection position between the adjacent two floors; when planning the path, consider the preset stair connection position as an impassable position and planning the path according to the preset strategy; and
receiving the path operation instruction, which comprises an instruction that needs to pass through a preset stair connection position between the adjacent two floors, when planning the path, setting the preset stair connection position as an intermediate destination position and planning the path according to the preset strategy.

20. The non-transitory storage medium according to claim 18, wherein responsive to that the target floor and the initial floor of the robot in the target building are separated by at least one floor in the target building, generating an indoor expected passable map according to the target floor and the initial floor of the robot further comprises:
obtaining a single-floor full map of the initial floor or obtaining a single-floor partial map of the initial floor based on the current position;
obtaining a single-floor full map of the target floor or obtaining a single-floor partial map of the target floor according to the target position;
obtaining a single-floor full map or a single-floor partial map of each floor between the initial floor and the target floor;
obtaining a plurality of stair connection positions between the adjacent two floors from the initial floor, the target floor, and the floors between the initial floor and the target floor;
generating the indoor expected passable map according to the single-floor full map of the initial floor or the single-floor partial map of the initial floor, the single-floor full map of the target floor or the single-floor partial map of the target floor, the single-floor full map or partial map of the floor between the initial floor and the target floor, and a plurality of stair connection positions between the adjacent two floors from the initial floor, the target floor, and the floors between the initial floor and the target floor;
responsive to that the stair connection positions between adjacent two floors are all in impassable state, and receiving no path operation instruction, planning the path according to a preset strategy after changing at least one of the stair connection positions between adjacent two floors to a passable state and
responsive to that the stair connection positions between adjacent two floors are all in impassable state and receiving no path operation instruction, planning the path according to the preset strategy after assuming all the stair connection positions are in passable state, and changing the stair connection positions between the adjacent two floors on the planned path to passable stat; and
receiving a path operation instruction, which comprise an instruction that do not pass through a preset stair connection position between the adjacent two floors; and responsive to that the preset stair connection position is in passable state, changing the preset stair connection position to impassable state and planning the path according to the preset strategy; and responsive to that the preset stair connection position is in impassable state, then maintaining the impassable state and planning the path according to the preset strategy; and
receiving a path operation instruction, which comprises an instruction that needs to pass through a preset stair connection position between the adjacent two floors; and responsive to that the preset stair connection position is in impassable state, assuming the preset stair connection position is in passable state and changing the connection positions of other passable stairs to impassable stairs, and planning the path according to the preset strategy, then changing the preset stair connection position between the adjacent two floors on the planned path to a passable position; responsive to that the preset stair connection position is in passable state, changing the connection position of other passable stairs to impassable stairs and planning the path according to the preset strategy; and
receiving the path operation instruction, which comprises an instruction that does not pass through the preset stair connection position between the adjacent two floors; when planning the path, consider the preset stair connection position as an impassable position and planning the path according to the preset strategy; and
receiving the path operation instruction, which comprises an instruction that needs to pass through a preset stair connection position between the adjacent two floors, when planning the path, setting the preset stair connection position as an intermediate destination position and planning the path according to the preset strategy.
